(19) United States
(12) Patent Application Publication
(10) Pub. No.: US 2026/0356696 A1
(43) Pub. Date: Nov. 12, 2026

(54) WATER PURIFIERS

(71) Applicants: JIANGSU KINGCLEAN INTELLIGENT APPLIANCE CO., LTD., Suzhou (CN); KINGCLEAN ELECTRIC GREEN TECHNOLOGY (SUZHOU) CO., LTD., Suzhou (CN); KINGCLEAN ELECTRIC CO., LTD., Suzhou (CN)

(72) Inventors: Lei ZHANG, Suzhou (CN); Yu ZHOU, Suzhou (CN); Renbei ZHAO, Suzhou (CN); Le GAO, Suzhou (CN); Tingfeng XUE, Suzhou (CN)

(73) Assignees: JIANGSU KINGCLEAN INTELLIGENT APPLIANCE CO., LTD., Suzhou (CN); KINGCLEAN ELECTRIC GREEN TECHNOLOGY (SUZHOU) CO., LTD., Suzhou (CN); KINGCLEAN ELECTRIC CO., LTD., Suzhou (CN)

(21) Appl. No.: 19/733,960

(22) Filed: Jul. 7, 2026

Related U.S. Application Data
(63) Continuation-in-part of application No. PCT/CN2024/137078, filed on Dec. 5, 2024.

(30) Foreign Application Priority Data
Jan. 9, 2024 (CN) 202420052862.8

(51) Int. Cl. C02F 1/00

(52) U.S. Cl. CPC C02F 1/001; C02F 2201/004; C02F 2201/005

(57) ABSTRACT

The present disclosure relates to a water purifier. The water purifier comprises a liquid reservoir, a first valve assembly and a liquid storage member, wherein the liquid reservoir is provided with a first connecting pipe in communication with an inner cavity of the liquid reservoir, and the liquid storage member is provided with a second connecting base in communication with an inner cavity of the liquid storage member, the first valve assembly comprises a first valve core and a sealing ring which are located within the first connecting pipe, and the first valve core is configured to open or close the first valve assembly correspondingly when the second connecting base is inserted into or removed from the first connecting pipe; the sealing ring fits with the first connecting pipe in a sealing manner at one end, and is provided with a fitting portion at the other end, and the fitting portion is movably sleeved on the first valve core; and the first connecting pipe, the first valve core and the sealing ring together form an accommodating space which is in communication with the inner cavity of the liquid reservoir when the first valve assembly is opened. The water purifier of the present application can prevent water leakage during removal of the liquid storage member.

### CROSS-REFERENCE TO RELATED APPLICATIONS

This application is a Continuation-in-part of International Application No. PCT/CN 2024/137078, filed on Dec. 5, 2024, which claims priority to Chinese Patent Application No. 202420052862.8, filed on Jan. 9, 2024, the entire contents of each of which are hereby incorporated by reference.

### TECHNICAL FIELD

The present disclosure relates to the technical field of water purification, and in particular to a water purifier.

### BACKGROUND

With increasing popularity of water purifiers, in order to facilitate water refilling or cleaning, a liquid storage unit (e.g., a purified water tank or raw water tank) is generally designed to be detachable from a liquid storage device (e.g., a base or a liquid level box) in a pluggable manner. In related technologies, a water inlet of the liquid storage unit is detachably connected to a water supply interface of the water storage device (such as the liquid reservoir) via a plug-and-pull fit. However, when users perform plugging or unplugging operations on the liquid storage unit, water leakage often occurs at the connection between the water inlet of the liquid storage unit and the water supply interface of the water storage device, resulting in a poor user experience.

### SUMMARY

One or more embodiments of the present disclosure provide a water purifier, which can avoid water leakage when taking out the liquid storage unit, thereby improving the user experience.

In order to achieve the above objective, in a first aspect, a water purifier provided by an embodiment of the present disclosure comprises a liquid reservoir, a first valve assembly, and a liquid storage unit; the liquid reservoir is provided with a first connecting tube in communication with an inner cavity of the liquid reservoir, and the liquid storage unit is provided with a second connector in communication with an inner cavity of the liquid storage unit; the first valve assembly includes a first valve core and a sealing ring located in the first connecting tube, and the first valve core is configured to open or close the first valve assembly when the second connector is inserted into or pulled out of the first connecting tube; one end of the sealing ring is sealingly engaged with the first connecting tube, the other end of the sealing ring is provided with a mating portion, the mating portion is movably sleeved on the first valve core, and the first connecting tube, the first valve core, and the sealing ring together form an accommodating space, and the accommodating space is in communication with the inner cavity of the liquid reservoir when the first valve assembly is open.

In one embodiment, the first valve core is provided with a sealing member, and the sealing member is configured to sealingly cooperate with the mating portion.

In one embodiment, the water purifier further includes a second valve assembly disposed in the second connector; the second valve assembly includes a driving member, and when the second connector is detached from the first connecting tube, the sealing member sealingly cooperates with the mating portion; when the second connector is inserted into the first connecting tube, the driving member presses against the mating portion and drives the mating portion to disengage from the sealing member, so that the second connector is in communication with the inner cavity of the liquid reservoir through the accommodating space.

In one embodiment, the sealing ring is configured as an elastic member, the mating portion is capable of moving along a first direction under the driving of the driving member, or elastically resetting along a second direction opposite to the first direction, so that a volume of the accommodating space becomes smaller or larger, wherein the first direction is an insertion direction in which the second connector is inserted into the first connecting tube.

In one embodiment, the second valve assembly includes a second valve seat and a second valve core passing through the second valve seat, the second valve seat is connected in the second connector, the second valve core is capable of moving relative to the second connector toward a second direction, or elastically resetting toward a first direction opposite to the second direction, to open or close a valve port of the second valve seat; and the second valve seat forms the driving member; the second direction is a withdrawal direction in which the second connector is pulled out relative to the first connecting tube.

In one embodiment, a setting position of the second valve seat corresponds to a setting position of the mating portion, a setting position of the second valve core corresponds to a setting position of the first valve core, a state where the second connector is located in the first connecting tube and the second valve seat just contacts the mating portion is designated as an initial state, and in the initial state, there is a gap between the first valve core and the second valve core, or the first valve core and the second valve core contact each other and do not transmit force to each other.

In one embodiment, the mating portion is in clearance fit with the first valve core, and the sealing member seals an end surface of the mating portion facing the second valve core.

In one embodiment, the first valve core includes a first valve core body and a plurality of first ribs, the plurality of first ribs are arranged at intervals and around a peripheral surface of the first valve core body, the sealing member is provided at an end of the first valve core body away from the inner cavity of the liquid reservoir and is connected to each first rib.

In one embodiment, the first valve core includes a first valve core body and a plurality of first ribs, the plurality of first ribs are arranged at intervals and around a peripheral surface of the first valve core body; the mating portion is configured as an annular member, is sleeved on an outer peripheral side of each first rib, and is in clearance fit with the outer peripheral side of each first rib, and an inner diameter of the mating portion is less than 7 mm.

In one embodiment, the mating portion and the sealing member are both configured as annular members.

In one embodiment, the sealing member is configured as a disc-shaped structure, and an outer diameter of the sealing member is greater than an inner diameter of the mating portion.

In one embodiment, the sealing ring includes an annular main body portion and a necking portion, both the necking portion and the mating portion are disposed around an outer side of the first valve core, one end of the necking portion is connected to the main body portion, and the other end of the necking portion is connected to the mating portion.

In one embodiment, both the necking portion and the mating portion are located inside the main body portion; or the main body portion, the necking portion, and the mating portion are arranged sequentially along the second direction.

In one embodiment, an end of the main body portion away from the necking portion is provided with a first flanging portion that is folded outward, an outer peripheral surface of the main body portion presses against an inner wall of the first connecting tube, and the first flanging portion is sleeved on an end of the first connecting tube away from the liquid reservoir.

In one embodiment, the water purifier further includes a housing, the liquid reservoir is connected to the housing, the housing is provided with a connecting pipe through which the first connecting tube is inserted, an end of the connecting pipe is provided with a second flanging portion that is folded inward, and the second flanging portion presses the first flanging portion tightly against the end of the first connecting tube away from the liquid reservoir.

In one embodiment, an inner diameter of the mating portion is less than or equal to an inner diameter of the second valve seat; and projections of surfaces of the mating portion and the second valve seat that face each other on a plane perpendicular to the first direction have an overlapping portion.

In one embodiment, an outer diameter of the second connector is less than an inner diameter of the main body portion; an annular protruding portion is provided inside the main body portion, and when the second connector is inserted into the first connecting tube, the protruding portion presses against an outer wall of the second connector.

In one embodiment, surfaces of the mating portion and the second valve seat facing each other are designated as a first surface and a second surface, respectively; in the initial state, an end of the first valve core away from the inner cavity of the liquid reservoir protrudes beyond the first surface; a distance D1 between an end surface of the first valve core facing the second valve core and the first surface and a distance D2 between an end surface of the second valve core facing the first valve core and the second surface satisfy: D1<D2.

In one embodiment, an end surface of the mating portion away from the first surface is designated as a third surface; a first step portion that is locally protruding is provided between two ends of the first valve core, and the first step portion is configured to block a moving path of the mating portion along the first direction; the first step portion includes a first step surface extending radially along the first valve core, and the first step surface is arranged opposite to the third surface; a distance D3 between an end surface of the first valve core facing the second valve core and the first step surface and a thickness dimension D4 of the mating portion along the first direction satisfy: D3>D4.

In one embodiment, the first valve assembly further includes a first valve seat, the first valve core passes through the first valve seat, the first valve seat is connected inside the first connecting tube, the first valve core is capable of moving relative to the first valve seat along a first direction, or elastically resetting along a second direction opposite to the first direction, to open or close a valve port of the first valve seat, and the first direction is an insertion direction in which the second connector is inserted into the first connecting tube.

In one embodiment, the first valve seat includes a first valve seat body, the first valve seat body is configured with a first accommodation chamber with openings at both ends, and the opening facing the inner cavity of the liquid reservoir forms the valve port of the first valve seat; the first valve core passes through the first accommodation chamber and is in guiding cooperation with a wall of the first accommodation chamber, and a first sealing end of the first valve core enters the inner cavity of the liquid reservoir through the valve port of the first valve seat.

In one embodiment, the first valve assembly further includes a first elastic member, the first elastic member is disposed between an inner wall of the first valve seat and the first valve core, and is configured to apply an elastic force toward the second direction to the first valve core, continuously.

In one embodiment, an outer surface of the first valve core is provided with at least one second step portion, and two ends of the first elastic member press between the inner wall of the first valve seat and the at least one second step portion, respectively.

In one embodiment, the second valve seat includes a second valve seat body, the second valve seat body is configured with a second accommodation chamber with openings at both ends, and the opening away from the inner cavity of the liquid storage unit forms the valve port of the second valve seat; the second valve core passes through the second accommodation chamber and is in guiding cooperation with a wall of the second accommodation chamber, and a second sealing end of the second valve core seals the valve port of the second valve seat when moving along the first direction.

In one embodiment, an edge of the valve port of the second valve seat is provided with a third flanging portion that is folded inward, and the third flanging portion is configured to stop and cooperate with the second sealing end of the second valve core.

In one embodiment, the second valve assembly further includes a second elastic member, the second elastic member is disposed between an inner wall of the second valve seat and the second sealing end of the second valve core, and is configured to apply an elastic force toward the first direction to the second valve core, continuously.

In one embodiment, an outer wall of the liquid storage unit is configured with a mounting chamber in communication with the inner cavity of the liquid storage unit, and the second connector is installed in the mounting chamber.

In one embodiment, the liquid reservoir is a communicating vessel, and the liquid storage unit is a clean water tank; or, the liquid reservoir is a raw water tank base, and the liquid storage unit is a raw water tank; or, the liquid reservoir is a raw water tank, and the liquid storage unit is a raw water tank base.

In one embodiment, the liquid reservoir is a communicating vessel, and the liquid storage unit is a clean water tank; the water purifier further includes: a filter and a water pump, the filter is in communication with the inner cavity of the communicating vessel, and the water pump draws water from the clean water tank through the communicating vessel; the water purifier further includes a level box, the communicating vessel is in communication with the level box, and when the water pump draws water, the water in the level box and the clean water tank both decreases.

In one embodiment, the water purifier further includes a filter; the liquid reservoir is a raw water tank base, and the liquid storage unit is a raw water tank, and the raw water tank base is configured to provide raw water from the raw water tank to the filter.

Advantageous effects of the water purifier:

One end of the sealing ring is in sealing cooperation with the first connecting tube, and the other end of the sealing ring is provided with a mating portion. The mating portion is movably sleeved on the first valve core. The first connecting tube, the first valve core, and the sealing ring together form an accommodating space. Consequently, when the second connector is not inserted into the first connecting tube, water leaking from the side of the liquid reservoir can be temporarily stored in the accommodating space, effectively preventing water from leaking out of the first connecting tube.

In a second aspect, the present disclosure provides a water purifier, comprising a liquid reservoir, a liquid storage unit, a first valve assembly, and a second valve assembly; the liquid reservoir is provided with a first connecting tube in communication with an inner cavity of the liquid reservoir; the liquid storage unit is provided with a second connector in communication with an inner cavity of the liquid storage unit; the first valve assembly includes a sealing ring and a first valve core that reciprocates along a length direction of the first connecting tube to open or close the inner cavity of the liquid reservoir; the second valve assembly includes a second valve seat and a second valve core provided on the second valve seat; the second valve core reciprocates along a length direction of the second connector to open or close the inner cavity of the liquid storage unit; one end of the sealing ring is sealingly engaged with the first connecting tube, and the other end of the sealing ring is provided with a mating portion. The mating portion is movably sleeved on a periphery of the first valve core; a setting position of the second valve seat corresponds to a setting position of the mating portion; a setting position of the second valve core corresponds to a setting position of the first valve core; a state where the second connector is located in the first connecting tube and the second valve seat just contacts the mating portion is designated as an initial state; in the initial state, there is a gap between the first valve core and the second valve core, or the first valve core and the second valve core contact each other and do not transmit force to each other.

In one embodiment, the first valve assembly further includes a first valve seat. The first valve core is inserted through the first valve seat. The first valve seat is connected to the first connecting tube. The first valve core is configured to move relative to the first valve seat along a first direction, or elastically reset along a second direction opposite to the first direction, to open or close a valve port of the first valve seat. The first direction is an insertion direction in which the second connector is inserted into the first connecting tube.

In one embodiment, the second valve core is configured to move relative to the second valve seat toward a second direction, or elastically reset toward a first direction, to open or close a valve port of the second valve seat.

In one embodiment, the mating portion is in clearance fit with the first valve core.

In one embodiment, the first valve core includes a first valve core body and a plurality of first ribs. The plurality of first ribs are arranged at intervals and around a peripheral surface of the first valve core body. The mating portion is configured as an annular member, is sleeved on an outer peripheral side of each first rib, and is in clearance fit with the outer peripheral side of each first rib. An inner diameter of the mating portion is less than 7 mm.

In one embodiment, the first connecting tube, the first valve core, and the sealing ring together form an accommodating space. The sealing ring is configured as an elastic member. The mating portion is configured to move along a first direction under driving of the second valve seat, or elastically reset along a second direction, to reduce or increase a volume of the accommodating space.

In one embodiment, the sealing ring includes an annular main body portion and a necking portion. The necking portion and the mating portion are disposed around an outer side of the first valve core. One end of the necking portion is connected to the main body portion, and the other end of the necking portion is connected to the mating portion.

In one embodiment, the necking portion and the mating portion are both located on an inner side of the main body portion; or the main body portion, the necking portion, and the mating portion are arranged in sequence along the second direction.

In one embodiment, an end of the main body portion away from the necking portion is provided with a first flanging portion that is folded outward. A peripheral surface of the main body portion presses against an inner wall of the first connecting tube. The first flanging portion is sleeved on an end of the first connecting tube away from the liquid reservoir.

In one embodiment, the water purifier further includes a housing. An end of the housing is provided with a second flanging portion that is folded inward. The second flanging portion presses the first flanging portion tightly against the end of the first connecting tube away from the liquid reservoir.

In one embodiment, an inner diameter of the mating portion is less than or equal to an inner diameter of the second valve seat. Further, projections of surfaces of the mating portion and the second valve seat that face each other on a plane perpendicular to the first direction have an overlapping portion.

In one embodiment, an outer diameter of the second connector is less than an inner diameter of the main body portion. An annular protruding portion is provided on an inner side of the main body portion. When the second connector is inserted into the first connecting tube, the protruding portion presses against an outer wall of the second connector.

In one embodiment, opposite surfaces of the mating portion and the second valve seat are designated as a first surface and a second surface, respectively. In the initial state, an end of the first valve core away from the inner cavity of the liquid reservoir protrudes beyond the first surface. A distance D1 between an end surface of the first valve core facing the second valve core and the first surface and a distance D2 between an end surface of the second valve core facing the first valve core and the second surface satisfy: D1<D2.

In one embodiment, an end surface of the mating portion away from the first surface is designated as a third surface. A first step portion that is partially protruding is provided between two ends of the first valve core. The first step portion is configured to block a moving path of the mating portion along the first direction. The first step portion includes a first step surface extending radially along the first valve core. The first step surface is arranged opposite to the third surface. A distance D3 between the end surface of the first valve core facing the second valve core and the first step surface and a thickness dimension D4 of the mating portion along the first direction satisfy: D3>D4.

In one embodiment, the first valve seat includes a first valve seat body. The first valve seat body is configured with a first accommodation chamber with openings at two ends. The opening facing the inner cavity of the liquid reservoir forms the valve port of the first valve seat. The first valve core passes through the first accommodation chamber and is in guiding fit with a wall of the first accommodation chamber. A first sealing end of the first valve core enters the inner cavity of the liquid reservoir through the valve port of the first valve seat.

In one embodiment, the first valve assembly further includes a first elastic member, the first elastic member is arranged between an inner wall of the first valve seat and the first valve core, and is configured to apply an elastic force toward the second direction to the first valve core, continuously.

In one embodiment, an outer surface of the first valve core is provided with at least one second step portion, and two ends of the first elastic member press between the inner wall of the first valve seat and the at least one second step portion, respectively.

In one embodiment, the second valve seat includes a second valve seat body, the second valve seat body is configured with a second accommodation chamber with openings at both ends, and the opening away from an inner cavity of the liquid storage unit forms a valve port of the second valve seat; the second valve core passes through the second accommodation chamber and is in guiding cooperation with a wall of the second accommodation chamber, and a second sealing end of the second valve core seals the valve port of the second valve seat when moving along the first direction.

In one embodiment, the second valve assembly further includes a second elastic member, the second elastic member is arranged between an inner wall of the second valve seat and a second sealing end of the second valve core, and is configured to continuously apply an elastic force toward the first direction to the second valve core; the first valve assembly further includes a first elastic member, the first elastic member is arranged between an inner wall of the first valve seat and the first valve core, and is configured to continuously apply an elastic force toward the second direction to the first valve core; an elastic coefficient of the second elastic member is less than an elastic coefficient of the first elastic member.

In one embodiment, an outer wall of the liquid storage unit is configured with a mounting chamber in communication with an inner cavity of the liquid storage unit, and the second connector is installed in the mounting chamber.

In one embodiment, the liquid reservoir communicates with atmosphere, and a water level sensor for detecting a water level is provided in the liquid reservoir.

In one embodiment, the first connecting tube, the first valve core, and the sealing ring together form an accommodating space, and the accommodating space communicates with an inner cavity of the liquid reservoir when the first valve assembly is open.

In one embodiment, a sealing member is provided on the first valve core, and the sealing member is configured to sealingly cooperate with the mating portion to seal the accommodating space.

In one embodiment, the liquid reservoir is a level box, and the liquid storage unit is a clean water tank; or, the liquid reservoir is a raw water tank base, and the liquid storage unit is a raw water tank; or, the liquid reservoir is a raw water tank, and the liquid storage unit is a raw water tank base.

Beneficial effects of the above water purifier: by having one end of the sealing ring sealingly engaged with the first connecting tube and the other end provided with the mating portion, and the mating portion movably sleeved on the periphery of the first valve core, the mating portion is movable relative to the first valve core along a length direction of the first connecting tube; a setting position of the second valve seat corresponds to a setting position of the mating portion; when the second connector is inserted into the first connecting tube and the second valve seat just contacts the mating portion, there is a gap between the first valve core and the second valve core, or the first valve core and the second valve core contact each other without transmitting force. With such a configuration, since one end of the sealing ring is sealingly engaged with the first connecting tube, when the second connector is inserted into the first connecting tube and the second valve seat just contacts the mating portion, it contacts the mating portion to form a seal; at this moment, there is a gap between the first valve core and the second valve core, and the two are not in contact, or the first valve core and the second valve core contact each other without transmitting force; thus, both the first valve assembly and the second valve assembly are in a closed state; as the insertion of the second connector deepens, the mating portion is pushed by the second valve seat to move relative to the first valve core in the insertion direction and undergoes elastic deformation, causing the second valve seat and the mating portion to press tightly and maintain a sealed state; during this process, regardless of whether the first valve assembly and the second valve assembly are opened, water inside the first valve assembly and the second valve assembly cannot leak out from the junction between the mating portion and the second valve seat; therefore, no water leakage occurs during the entire insertion process of the second connector.

In a third aspect, the present disclosure provides a water purifier, comprising: a liquid reservoir, comprising: a first connecting tube, a first valve assembly, and a sealing ring; the first valve assembly is installed on the first connecting tube; the first valve core includes a first sealing end and an opposite end arranged opposite to the first sealing end; one end of the sealing ring is in sealing cooperation with the first connecting tube, the other end of the sealing ring is provided with a mating portion, and the mating portion is movably sleeved on a periphery of the opposite end; a liquid storage unit, detachably installed on the liquid reservoir; wherein the first valve core, the first connecting tube, and the sealing ring together form an accommodating space; when the liquid storage unit is not installed on the liquid reservoir, the mating portion is located at the opposite end, the first valve assembly is closed, the first sealing end is closed, and an inner cavity of the liquid reservoir is disconnected from the accommodating space.

In one embodiment, when the liquid storage unit is installed on the liquid reservoir, the mating portion is located between the opposite end and the first sealing end, the first valve assembly is open, the first sealing end is open, and an inner cavity of the liquid reservoir communicates with the accommodating space.

In one embodiment, the liquid storage unit is provided with a second connector in communication with an inner cavity of the liquid storage unit, the first valve core is configured to open or close the first valve assembly while the second connector is inserted into or pulled out of the first connecting tube; the water purifier further includes a second valve assembly provided in the second connector; the second valve assembly includes a driving member, and when the second connector is inserted into the first connecting tube, the driving member presses against the mating portion and drives the mating portion to detach from the opposite end, so that the second connector communicates with an inner cavity of the liquid reservoir through the accommodating space.

In one embodiment, the sealing ring is configured as an elastic member, the mating portion is movable along a first direction under driving of the driving member, or elastically resets along a second direction opposite to the first direction, to reduce or increase a volume of the accommodating space, and the first direction is an insertion direction in which the second connector is inserted into the first connecting tube.

In one embodiment, the second valve assembly includes a second valve seat and a second valve core disposed through the second valve seat, the second valve seat is connected inside the second connector, the second valve core is movable relative to the second connector toward a second direction, or elastically resets toward a first direction opposite to the second direction, to open or close a valve port of the second valve seat; the second valve seat forms the driving member; the second direction is a withdrawal direction in which the second connector is pulled out relative to the first connecting tube.

In one embodiment, a setting position of the second valve seat corresponds to a setting position of the mating portion, a setting position of the second valve core corresponds to a setting position of the first valve core, a state where the second connector is located in the first connecting tube and the second valve seat just contacts the mating portion is designated as an initial state, and in the initial state, there is a gap between the first valve core and the second valve core, or the first valve core and the second valve core contact each other and do not transmit force to each other.

In one embodiment, a sealing member is provided on the opposite end of the first valve core, and the sealing member is configured to sealingly cooperate with the mating portion; when the liquid storage unit is not installed on the liquid reservoir, the second connector is detached from the first connecting tube, and the sealing member sealingly cooperates with the mating portion.

In one embodiment, the mating portion is in clearance fit with the first valve core, and the sealing member seals against an end surface of the mating portion facing the second valve core.

In one embodiment, the first valve core includes a first valve core body and a plurality of first ribs. The plurality of first ribs are arranged at intervals and around a peripheral surface of the first valve core body. The sealing member is provided at an end of the first valve core body away from the inner cavity of the liquid reservoir and is connected to each first rib.

In one embodiment, both the mating portion and the sealing member are configured as annular members.

In one embodiment, the sealing member is configured as a disc-shaped structure. An outer diameter of the sealing member is greater than an inner diameter of the mating portion to seal the accommodating space.

In one embodiment, the first valve core includes a first valve core body and a plurality of first ribs. The plurality of first ribs are arranged at intervals and around a peripheral surface of the first valve core body. The mating portion is configured as an annular member, is sleeved on an outer peripheral side of each first rib, and is in clearance fit with the outer peripheral side of each first rib. An inner diameter of the mating portion is less than 7 mm.

In one embodiment, the sealing ring includes an annular main body portion and a necking portion. Both the necking portion and the mating portion are disposed around an outer side of the first valve core. One end of the necking portion is connected to the main body portion, and the other end of the necking portion is connected to the mating portion.

In one embodiment, both the necking portion and the mating portion are located inside the main body portion; or, the main body portion, the necking portion, and the mating portion are arranged sequentially along the second direction.

In one embodiment, an end of the main body portion away from the necking portion is provided with a first flanging portion that is folded outward. A peripheral surface of the main body portion presses against an inner wall of the first connecting tube. The first flanging portion is sleeved on an end of the first connecting tube away from the liquid reservoir.

In one embodiment, the water purifier further includes a housing. The liquid reservoir is connected to the housing. The housing is provided with a connecting pipe through which the first connecting tube is inserted. An end of the connecting pipe is provided with a second flanging portion that is folded inward. The second flanging portion presses the first flanging portion tightly against the end of the first connecting tube away from the liquid reservoir.

In one embodiment, an inner diameter of the mating portion is less than or equal to an inner diameter of the second valve seat; and projections of surfaces of the mating portion and the second valve seat facing each other on a plane perpendicular to the first direction have an overlapping portion.

In one embodiment, an annular protruding portion is provided inside the main body portion. When the second connector is inserted into the first connecting tube, the protruding portion presses against an outer wall of the second connector. When the second connector is inserted into the first connecting tube, at least a portion of the second connector is located between the mating portion and the main body portion.

In one embodiment, surfaces of the mating portion and the second valve seat facing each other are respectively designated as a first surface and a second surface. In the initial state, an end of the first valve core away from the inner cavity of the liquid reservoir protrudes beyond the first surface. A distance D1 between an end surface of the first valve core facing the second valve core and the first surface and a distance D2 between an end surface of the second valve core facing the first valve core and the second surface satisfy: D1<D2.

In one embodiment, an end surface of the mating portion away from the first surface is designated as a third surface. A first step portion that is partially protruding is provided between two ends of the first valve core. The first step portion is configured to block a moving path of the mating portion along the first direction. The first step portion includes a first step surface extending radially along the first valve core. The first step surface is arranged opposite to the third surface. A distance D3 between an end surface of the first valve core facing the second valve core and the first step surface and a thickness dimension D4 of the mating portion along the first direction satisfy: D3>D4.

In one embodiment, the first valve assembly further includes a first valve seat. The first valve core passes through the first valve seat. The first valve seat is connected to the first connecting tube. The first valve core is capable of moving relative to the first valve seat along a first direction, or elastically resetting along a second direction opposite to the first direction, to open or close a valve port of the first valve seat. The first direction is an insertion direction in which the second connector is inserted into the first connecting tube.

In one embodiment, the first valve seat includes a first valve seat body. The first valve seat body is configured with a first accommodation chamber with openings at both ends. The opening facing the inner cavity of the liquid reservoir forms the valve port of the first valve seat. The first valve core passes through the first accommodation chamber and is in guiding cooperation with a wall of the first accommodation chamber. A first sealing end of the first valve core enters the inner cavity of the liquid reservoir through the valve port of the first valve seat.

In one embodiment, the first valve assembly further includes a first elastic member. The first elastic member is arranged between an inner wall of the first valve seat and the first valve core, and is configured to apply an elastic force toward the second direction to the first valve core, continuously.

In one embodiment, an outer surface of the first valve core is provided with at least one second step portion. Two ends of the first elastic member press between the inner wall of the first valve seat and the at least one second step portion, respectively.

In one embodiment, the second valve seat includes a second valve seat body. The second valve seat body is configured with a second accommodation chamber with openings at both ends. The opening away from the inner cavity of the liquid storage unit forms the valve port of the second valve seat. The second valve core passes through the second accommodation chamber and is in guiding cooperation with a wall of the second accommodation chamber. A second sealing end of the second valve core seals the valve port of the second valve seat when moving along the first direction.

In one embodiment, an edge of the valve port of the second valve seat is provided with a third flanging portion that is folded inward. The third flanging portion is configured to stop and cooperate with the second sealing end of the second valve core.

In one embodiment, the second valve assembly further comprises a second elastic member; the second elastic member is disposed between an inner wall of the second valve seat and the second sealing end of the second valve core, and is configured to always apply an elastic force toward the first direction to the second valve core. Preferably, an elastic coefficient of the second elastic member is less than an elastic coefficient of the first elastic member.

In one embodiment, an outer wall of the liquid storage unit is configured with a mounting chamber in communication with the inner cavity of the liquid storage unit. The second connector is installed in the mounting chamber.

Beneficial effects of the above water purifier: one end of the sealing ring is in sealing cooperation with the first connecting tube, and the other end of the sealing ring is provided with the mating portion. The mating portion is movably sleeved on the first valve core. The first connecting tube, the first valve core, and the sealing ring together form the accommodating space. Consequently, when the second connector is not inserted into the first connecting tube, water leaking from the side of the liquid reservoir can be temporarily stored in the accommodating space, effectively preventing water from leaking out of the first connecting tube.

### BRIEF DESCRIPTION OF THE DRAWINGS

The present description will be further described by way of exemplary embodiments, which will be described in detail by means of the accompanying drawings. These embodiments are not restrictive, and in these embodiments, the same numbers represent the same structures, wherein:

FIG. 1 is a schematic diagram illustrating a structure of a liquid reservoir and a liquid storage unit cooperating with each other in a water purifier according to some embodiments of the present disclosure;

FIG. 2 is a schematic diagram illustrating a cross-sectional structure of a water purifier according to some embodiments of the present disclosure;

FIG. 3 is a partial enlarged view of a portion A in FIG. 2;

FIG. 4a is a schematic diagram illustrating a structure of a first valve core in a water purifier according to some embodiments of the present disclosure;

FIG. 4b is a schematic diagram illustrating a structure of a second valve seat in a water purifier according to some embodiments of the present disclosure;

FIG. 5 is a schematic diagram illustrating a structure of a water purifier in an initial state according to some embodiments of the present disclosure;

FIG. 6 is a schematic diagram illustrating a structure of a water purifier in a first state according to some embodiments of the present disclosure;

FIG. 7 is a schematic diagram illustrating a structure of a water purifier in a second state according to some embodiments of the present disclosure;

FIG. 8 is a schematic diagram illustrating a structure of a water purifier in a third state according to some embodiments of the present disclosure;

FIG. 9 is a schematic diagram illustrating another structure of a first valve assembly in a water purifier according to some embodiments of the present disclosure;

FIG. 10 is a schematic diagram illustrating another structure of a second valve assembly in a water purifier according to some embodiments of the present disclosure;

FIG. 11 is a schematic diagram illustrating a structure of a water purifier according to some embodiments of the present disclosure;

FIG. 12 is another schematic diagram illustrating a structure of a water purifier according to some embodiments of the present disclosure;

FIG. 13 is a schematic diagram illustrating a structure of a liquid reservoir and a liquid storage unit cooperating with each other in a water purifier according to other embodiments of the present disclosure;

FIG. 14 is a schematic diagram illustrating a partial structure of a water purifier according to other embodiments of the present disclosure;

FIG. 15 is a schematic diagram illustrating a structure of a liquid storage unit according to other embodiments of the present disclosure;

FIG. 16 is a schematic diagram illustrating a cross-sectional structure of a water purifier according to other embodiments of the present disclosure;

FIG. 17 is a schematic diagram illustrating a structure of a water purifier in an initial state according to other embodiments of the present disclosure;

FIG. 18 is a schematic diagram illustrating a structure of a water purifier in a second state according to other embodiments of the present disclosure;

FIG. 19 is a schematic diagram illustrating a structure of a water purifier in a third state according to other embodiments of the present disclosure.

### DETAILED DESCRIPTION

In order to make the above-mentioned objectives, features, and advantages of the present disclosure more apparent and understandable, the specific embodiments of the present disclosure are described in detail below with reference to the accompanying drawings. Many specific details are set forth in the following description to provide a thorough understanding of the present disclosure. However, the present disclosure may be implemented in many other manners different from those described herein, and those skilled in the art may make similar improvements without departing from the spirit of the present disclosure. Therefore, the present disclosure is not limited by the specific embodiments disclosed below.

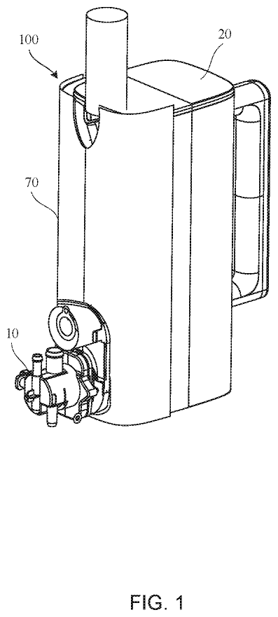

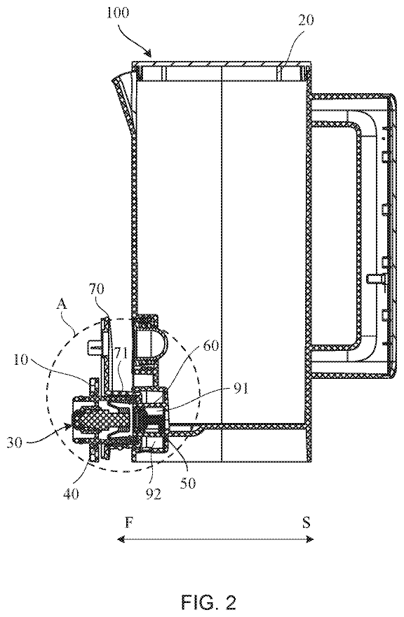

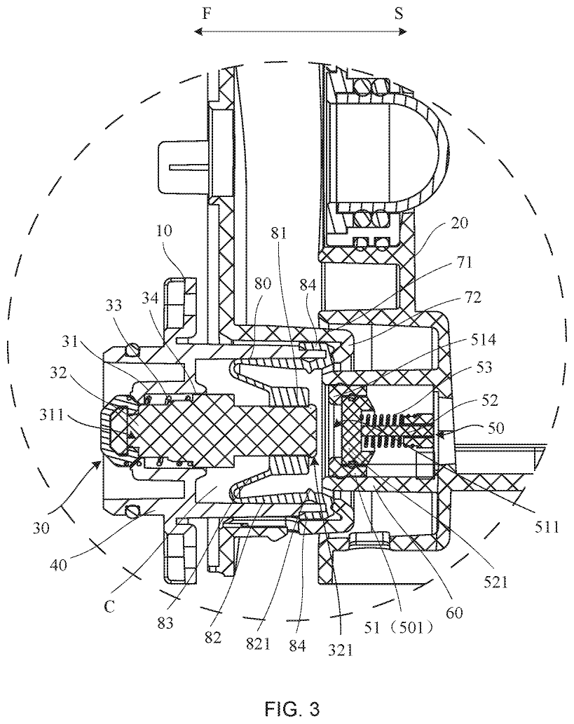

The water purifier according to embodiments of the present disclosure will be described below with reference to the accompanying drawings. FIG. 1 is a schematic diagram illustrating a structure of a liquid reservoir and a liquid storage unit cooperating with each other in a water purifier according to an embodiment of the present disclosure; FIG. 2 is a schematic diagram illustrating a cross-sectional structure of a water purifier according to an embodiment of the present disclosure; FIG. 3 is a partially enlarged view illustrating a portion A in FIG. 2.

Referring to FIG. 1, FIG. 2, and FIG. 3, a water purifier 100 is provided according to an embodiment of the present disclosure. The water purifier 100 comprises a liquid reservoir 10, a liquid storage unit 20, and a first valve assembly 30.

The liquid reservoir 10 is provided with a first connecting tube 40 in communication with an inner cavity of the liquid reservoir 10, and the liquid storage unit 20 is provided with a second connector 60 in communication with an inner cavity of the liquid storage unit 20; the first valve assembly 30 includes a first valve core 32 and a sealing ring 80 located in the first connecting tube 40, wherein the first valve core 32 is configured to open or close the first valve assembly 30 while the second connector 60 is inserted into or pulled out of the first connecting tube 40; one end of the sealing ring 80 is sealingly engaged with the first connecting tube 40, and the other end of the sealing ring 80 is provided with a mating portion 81, wherein the mating portion 81 is movably sleeved on the first valve core 32, and the first connecting tube 40, the first valve core 32, and the sealing ring 80 together form an accommodating space C, and the accommodating space C is in communication with the inner cavity of the liquid reservoir 10 when the first valve assembly 30 is open. The inner cavity Q refers to a cavity configured to pass water, temporarily store water, or store water.

With one end of the sealing ring 80 sealingly engaged with the first connecting tube 40, the other end provided with the mating portion 81, the mating portion 81 movably sleeved on the first valve core 32, and the first connecting tube 40, the first valve core 32, and the sealing ring 80 together forming the accommodating space C, when the second connector 60 is not inserted into the first connecting tube 40, the water leaking from a side of the liquid reservoir 10 may be temporarily stored in the accommodating space C, thereby effectively preventing the water from leaking out of the first connecting tube 40.

Additionally, when the liquid reservoir 10 or the liquid storage unit 20 is a raw water tank or a raw water tank base, after the two are separated, the water leaking from the side of the liquid reservoir 10 may also be temporarily stored in the accommodating space C, and may not leak to an outside of the liquid reservoir 10, which can prevent dripping. Furthermore, there is no possibility of foreign matter such as dust, or the like, entering the liquid reservoir 10.

The liquid reservoir 10 refers to a container for containing liquid or a fluid distribution channel, which is typically fixedly connected to or integrated into the main body of the water purifier 100. The liquid storage unit 20 refers to a component that is detachable and movable relative to the liquid reservoir 10, and is generally used for storing or supplying liquid. For example, the liquid storage unit 20 may be a purified water tank of the water purifier (for storing filtered water), and correspondingly, the liquid reservoir 10 is a connector or a liquid level box within the main body; alternatively, the liquid reservoir 10 may be a raw water tank base (an interface on the main body side), and the liquid storage unit 20 is a detachable raw water tank (the portion held by the user for manual water refilling).

An interior of the liquid reservoir 10 defines a cavity for communicating with the first connecting tube 40. The first connecting tube 40 is a hollow tubular structure, one end of which is in communication with the cavity of the liquid reservoir 10, and the other end of which extends outward and forms an interface for insertion of the liquid storage unit 20.

A main body of the liquid storage unit 20 may be a rigid pressure-resistant housing, the interior of which defines a cavity for storing purified water.

The second connector 60 is generally made of a plastic material with relatively good rigidity (e.g., Polyoxymethylene (POM) or Acrylonitrile Butadiene Styrene (ABS)), and is configured with a passage for fluid to pass through, and is in communication with an inner cavity of the liquid storage unit 20. In an in-use state, the second connector 60 is inserted into the first connecting tube 40 to form a fluid passage.

The first valve assembly 30 is a built-in self-sealing valve structure, the core function of which is to automatically switch a flow path between open and closed states during insertion and removal of the liquid storage unit 20, thereby preventing liquid leakage during assembly and disassembly. For example, the first valve assembly 30 is a miniature fluid control structure integrated at the interface of the liquid reservoir 10.

The first valve assembly 30 includes a first valve core 32 and a sealing ring 80. The first valve core 32 is a component that performs a switching action and is disposed in the internal cavity of the first connecting tube 40. For example, the first valve core 32 may be a columnar structure, a stepped shaft structure, or a cross-shaped structure with ribs. The sealing ring 80 is an elastic member that provides a sealing interface, is disposed on the first connecting tube 40, and is arranged to surround the first valve core 32.

The sealing ring 80 is a component for cooperating with the first valve core 32 to seal the accommodating space C. In some embodiments, the sealing ring 80 is made of an elastic material (e.g., a polymer material with good resilience, such as silicone, Ethylene-Propylene-Diene Monomer (EPDM), or Thermoplastic Elastomer (TPE)). In some embodiments, the sealing ring 80 is configured as an annular structure having a through hole at the center, and the through hole at the center is used for the first valve core 32 to pass therethrough.

One end (an outer end portion) of the sealing ring 80 sealingly abuts against the tube wall of the first connecting tube 40 by means of interference fit or press fit, so as to prevent water from leaking outward. The other end (an inner end portion) of the sealing ring 80 is configured with the mating portion 81. The outer end portion is a radially outer region of the sealing ring 80 for contacting a tube wall of the first connecting tube 40. The inner end portion is a region of the sealing ring 80 located radially inward of the central through hole and facing the first valve core 32.

The mating portion 81 refers to a component that cooperates with the first valve core 32. For example, the inner diameter of the mating portion 81 may be designed to be slightly smaller than the outer diameter of the first valve core 32 (i.e., a tight fit), so as to tightly embrace the first valve core 32 by utilizing the elasticity of the material, thereby forming an auxiliary seal. More descriptions regarding the cooperation between the mating portion 81 and the first valve core 32 may be found in the related descriptions below.

In some embodiments, the mating portion 81 is configured as an annular skirt or sleeve-like structure, which is movably sleeved onto the first valve core 32. The term “movably sleeved” as used herein means that the mating portion 81 and the first valve core 32 are not rigidly fixed to each other, but instead allow relative axial displacement therebetween. For example, the inner diameter of the mating portion 81 may be slightly larger than the outer diameter of the first valve core 32, or the mating portion 81 itself may have elastic deformability, such that it can slide along the first valve core 32 when being pushed.

The accommodating space C is a closed or semi-closed region enclosed jointly by the first connecting tube 40, the first valve core 32, and the sealing ring 80. For example, the accommodating space C is a region defined jointly by the inner wall of the first connecting tube 40, the outer surface of the first valve core 32, and the mating portion 81 of the sealing ring 80.

In a non-connected state (when the second connector 60 is not inserted into or has just come into contact with the first connecting tube 40), the first valve core 32 is closed, and the external opening of the accommodating space C is sealed by the sealing ring 80, that is, the accommodating space C is isolated from the environment outside the first connecting tube 40. When the first valve core 32 is opened, the accommodating space C forms, together with the inner cavity of the liquid reservoir 10, a temporarily communicating storage region, while its external opening remains sealed by the sealing ring 80, that is, the accommodating space C is isolated from the environment outside the first connecting tube 40. In this state, even if a small amount of water seeps from the side of the liquid reservoir 10, such water may enter the accommodating space C through the gaps around the first valve core 32 or through a specific water inlet channel, but may be confined within the accommodating space C and may not flow out of the first connecting tube 40.

In a connected state (after the second connector 60 is fully inserted into the first connecting tube 40), the first valve core 32 is pushed open, and the inner cavity of the liquid storage unit 20 is in communication with the inner cavity of the liquid reservoir 10 via the accommodating space C, thereby becoming part of the fluid transmission channel.

In some embodiments of the present disclosure, as shown in FIG. 3, the first valve core 32 is provided with a sealing member 321. The sealing member 321 is configured to sealingly engage with the mating portion 81, thereby sealing the accommodating space C. In this manner, when the second connector 60 is not inserted into the first connecting tube 40, the water can be better prevented from leaking out of the sealed accommodating space C.

The sealing member 321 refers to a sealing structure provided on the first valve core 32 for blocking a fluid path. For example, the sealing member 321 may be a columnar portion at an end of the first valve core 32 (e.g., a free end facing the second connector 60). A cross-sectional area of the sealing member 321 in a section perpendicular to an axial direction of the first valve core 32 may be greater than or equal to a cross-sectional area of the first valve core 32 in that direction.

Further, as shown in FIG. 3, the water purifier further includes a second valve assembly 50 provided in the second connector 60. The second valve assembly 50 includes a driving member 501. When the second connector 60 is detached from the first connecting tube 40, the sealing member 321 sealingly engages with the mating portion 81. When the second connector 60 is inserted into the first connecting tube 40, the driving member 501 presses against and drives the mating portion 81 to detach from the sealing member 321, so that the second connector 60 is in communication with the inner cavity of the liquid reservoir 10 via the accommodating space C. In this manner, when the second connector 60 is inserted into the first connecting tube 40, the water in the liquid reservoir 10 may flow through the accommodating space C and into the first connecting tube 40.

The second valve assembly 50 is a one-way valve mechanism provided on a side of the liquid storage unit 20, and is configured to prevent water inside the liquid storage unit 20 from flowing out when the second connector 60 is disengaged from the first connecting tube 40.

The driving member 501 is a portion of the second valve assembly 50 for mechanically interfering with the mating portion 81. The driving member 501 “unlocks” the sealed state of the accommodating space C by physically pushing the mating portion 81. For example, when the liquid storage unit 20 is a detachable raw water tank, the second valve assembly 50 is built into a water outlet of the raw water tank (e.g., the second connector 60 provided at the water outlet). When a user pushes the raw water tank into the main body (the liquid storage reservoir 10), the driving member 501 acts like a push rod to push the mating portion 81 to move. The second valve core 52 is a portion of the second valve assembly 50 for mechanically interfering with the first valve core 32. The second valve core 52 “unlocks” the sealed state of the first valve core 32 by physically pushing the first valve core 32. For example, when the liquid storage unit 20 is a detachable raw water tank, the second valve assembly 50 is built into the water outlet of the raw water tank (e.g., the second connector 60 provided at the water outlet). When a user pushes the raw water tank into the main body (the liquid reservoir 10), the second valve core 52 acts like a push rod to push the first valve core 32 to move.

In the non-connected state (when the second connector 60 is not inserted into or has just come into contact with the first connecting tube 40), the sealing member 321 is in surface contact or line contact with the mating portion 81 of the sealing ring 80, so as to cooperate with the mating portion 81 to block the passage between the accommodating space C and the external environment (on the side of the second connector 60).

During the insertion of the second connector 60 into the first connecting tube 40, the second valve assembly 50 moves along the axial direction of the second connector 60 together with the second connector 60. When the second connector 60 is inserted into the first connecting tube 40, the driving member 501 first contacts the mating portion 81 and applies an axial thrust to the mating portion 81. Since the mating portion 81 is movably sleeved onto the first valve core 32 and the sealing ring 80 is elastic, the mating portion 81 moves along the axial direction of the first valve core 32 against the elastic force of the sealing ring 80 (or the resistance of the first valve core 32), thereby separating from the sealing member 321. After the sealing member 321 and the mating portion 81 are separated, a water flow gap is formed therebetween, and the accommodating space C is no longer blocked, thereby achieving communication from the second connector 60 to the accommodating space C and then to the inner cavity of the liquid reservoir 10.

Further, the sealing ring 80 is configured as an elastic member. The mating portion 81 is capable of moving along the first direction F under a driving of the driving member 501, or elastically resetting along the second direction S opposite to the first direction F, so that the volume of the accommodating space C becomes smaller or larger. The first direction F is an insertion direction in which the second connector 60 is inserted into the first connecting tube 40. Such a configuration, when the second connector 60 is inserted into the first connecting tube 40, can squeeze out the stale water stored in the accommodating space C, thereby preventing bacteria from breeding there when the usage time is long. When the second connector 60 is fully inserted into the first connecting tube 40, the driving member 501 presses the mating portion 81 to a position closest to the liquid reservoir 10, at which time the volume of the accommodating space C is minimized.

In some embodiments, the sealing ring 80 is made of a polymer material having reversible deformation characteristics, either as a whole or at least in part thereof (e.g., in the vicinity of the mating portion 81). For example, the sealing ring 80 is preferably made of liquid silicone rubber or ethylene-propylene-diene monomer (EPDM) rubber, so as to provide elastic restoring force and sealing contact pressure.

The first direction F is defined as an axial direction in which the second connector 60 is inserted into the first connecting tube 40 (i.e., from right to left in FIGS. 2 and 3); the second direction S is the withdrawal direction (i.e., from left to right in FIGS. 2 and 3).

When the second connector 60 is inserted into the first connecting tube 40, the driving member 501 abuts against the mating portion 81 and applies a force thereto. Driven by the driving member 501, the mating portion 81 moves in the first direction F, and the axial length of the accommodating space C is shortened.

When the second connector 60 is withdrawn from the first connecting tube 40, the driving member 501 releases the thrust applied to the mating portion 81. At this point, the sealing ring 80 releases the stored potential energy to drive the mating portion 81 to move in the second direction S opposite to the first direction F, and the axial length of the accommodating space C returns to its original length or becomes longer.

In embodiments of the present disclosure, as shown in FIG. 3, the second valve assembly 50 includes a second valve seat 51 and a second valve core 52 passing through the second valve seat 51. The second valve seat 51 is connected in the second connector 60. The second valve core 52 is capable of moving relative to the second connector 60 toward the second direction S, or elastically resetting toward the first direction F opposite to the second direction S, to open or close a valve port 511 of the second valve seat 51; the second valve seat 51 forms the driving member 501. The second direction S is a withdrawal direction in which the second connector 60 is pulled out relative to the first connecting tube 40. The first direction F is an insertion direction in which the second connector 60 is inserted relative to the first connecting tube 40. Specifically, the second valve core 52 moves relative to the second connector 60 toward the second direction S to open the valve port 511 of the second valve seat 51. The second valve core 52 may elastically reset relative to the second connector 60 toward the first direction F to close the valve port 511 of the second valve seat 51.

Similarly, as shown in FIG. 3, the first valve assembly 30 further includes a first valve seat 31. The first valve core 32 passes through the first valve seat 31. The first valve seat 31 is connected to the first connecting tube 40. The first valve core 32 is capable of moving relative to the first valve seat 31 along the first direction F, or elastically resetting along the second direction S opposite to the first direction F, to open or close a valve port 311 of the first valve seat 31. Specifically, the first valve core 32 may move relative to the first valve seat 31 along the first direction F to open the valve port 311 of the first valve seat 31. The first valve core 32 may move relative to the first valve seat 31 along the second direction S to close the valve port 311 of the first valve seat 31.

The second valve assembly 50 is a one-way valve mechanism disposed on the side of the liquid storage unit 20, and is configured to control the communication between the inner cavity of the liquid storage unit 20 and the inner cavity of the liquid reservoir 10. The second valve assembly 50 is configured to automatically close when the liquid storage unit 20 is detached from the main body (the liquid reservoir 10), so as to prevent water inside the liquid storage unit 20 from flowing out.

The second valve seat 51 is a base body of the second valve assembly 50. The second valve seat 51 may be a flat plate-like base with a central hole, or a columnar structure with a central hole, or the like.

In some embodiments, the second valve seat 51 is fixed to an end of the second connector 60 proximate to the first connecting tube 40, for example, by means of interference fit, snap-fit, or thermal fusion.

The second valve seat 51 is provided with a valve port 511 extending along its axial direction, and the valve port 511 allows the second valve core 52 to perform a reciprocating linear motion therein.

The second valve core 52 is a movable member in the second valve assembly 50. The second valve core 52 may be a poppet valve, a ball valve, or a flat-plate valve.

The second valve core 52 may form an axial sliding fit with the second valve seat 51, so as to perform a reciprocating linear motion within the valve port 511 of the second valve seat 51. By means of axial displacement relative to the second valve seat 51, the second valve core 52 may change its position relative to the valve port 511, thereby opening or closing the valve hole 511 of the second valve seat 51, and thus realizing the blocking or opening of the flow passage.

When the second connector 60 is withdrawn relative to the first connecting tube 40, the second valve core 52 is no longer subjected to the supporting force from the first valve assembly 30. Under the action of the second elastic member 53, the second valve core 52 moves in the first direction F relative to the second connector 60, and thereby forms a sealing surface with the valve port 511, so as to close the valve port 511, thereby blocking communication between the liquid storage unit 20 and the outside, and preventing water inside the liquid storage unit 20 from flowing out.

When the second connector 60 is inserted into the first connecting tube 40, an end portion of the second valve core 52 comes into contact with the first valve core 32 or the first valve seat 31. As the second connector 60 continues to advance in the first direction F while the first valve core 32 or the first valve seat 31 temporarily remains stationary or exerts an opposing force, the second valve core 52 moves in the second direction S relative to the second connector 60. At this time, the second valve core 52 disengages from the valve port 511, such that the valve port 511 and the second valve core 52 are no longer in a sealed state and a gap is formed therebetween, thereby opening the valve port 511. After the valve port 511 of the second valve seat 51 is opened, water inside the liquid storage unit 20 is allowed to flow out.

In some embodiments, the second valve seat 51 may also serve as the driving member 501 for abutting against the mating portion 81 and driving the mating portion 81 to disengage from the sealing member 321. For example, an axial end surface of the second valve seat 51 on the side facing the first connecting tube 40 directly serves as a driving surface for contacting the mating portion 81 of the first valve assembly 30. The axial end surface of the second valve seat 51 on the side facing the first connecting tube 40 corresponds in position to the mating portion 81 (e.g., overlaps in projection along the axial direction), so as to ensure contact therebetween upon insertion.

When the second connector 60 is inserted into the first connecting tube 40, the second valve seat 51, being fixed in the second connector 60, moves axially together with the second connector 60, thereby applying a thrust to the mating portion 81, so that the mating portion 81 overcomes the elastic resistance of the sealing ring 80 and slides relative to the first valve core 32 in the first direction F. In this manner, the second valve seat 51 may form as the “driving member 501.”

In embodiments of the present disclosure, the liquid reservoir 10 may be configured to communicate with a water storage tank (not shown), such that the liquid storage unit 20 may communicate with the water storage tank via the liquid reservoir 10. The second connector 60 may be configured as a tubular member. Additionally, one end of the sealing ring 80 is sealingly engaged with an inner wall of the first connecting tube 40, and both the mating portion 81 and the sealing member 321 may be configured as annular members.

The mating portion 81 may be in clearance fit with an outer periphery of the first valve core 32. The sealing member 321 may seal against an end surface of the mating portion 81 facing the second valve core 52. The mating portion 81 is capable of moving relative to the first valve core 32 toward the first direction F or elastically resetting toward the second direction S.

In embodiments of the present disclosure, a setting position of the second valve seat 51 corresponds to a setting position of the mating portion 81, and a setting position of the second valve core 52 corresponds to a setting position of the first valve core 32. A state where the second connector 60 is located in the first connecting tube 40 and the second valve seat 51 just contacts the mating portion 81 is designated as an initial state, and in the initial state, there is a gap between the first valve core 32 and the second valve core 52, or the first valve core 32 and the second valve core 52 contact each other and do not transmit force to each other.

Positional correspondence refers to a relative positional relationship between two components in three-dimensional space. For ease of description, in some embodiments of the present disclosure, the positional correspondence is specifically embodied as coincidence of central axes.

A correspondence between the setting position of the second valve seat 51 and the setting position of the mating portion 81 means that the central axes of the second valve seat 51 and the mating portion 81 coincide. A correspondence between the setting position of the second valve core 52 and the setting position of the first valve core 32 means that the central axes of the second valve core 52 and the first valve core 32 coincide.

The initial state refers to a moment during insertion of the second connector 60 into the first connecting tube 40 when the end surface of the second valve seat 51 has just come into contact with the mating portion 81 of the sealing ring 80, but has not yet caused significant axial compressive deformation, and the first valve core 32 and the second valve core 52 have not yet begun to transmit an opening force.

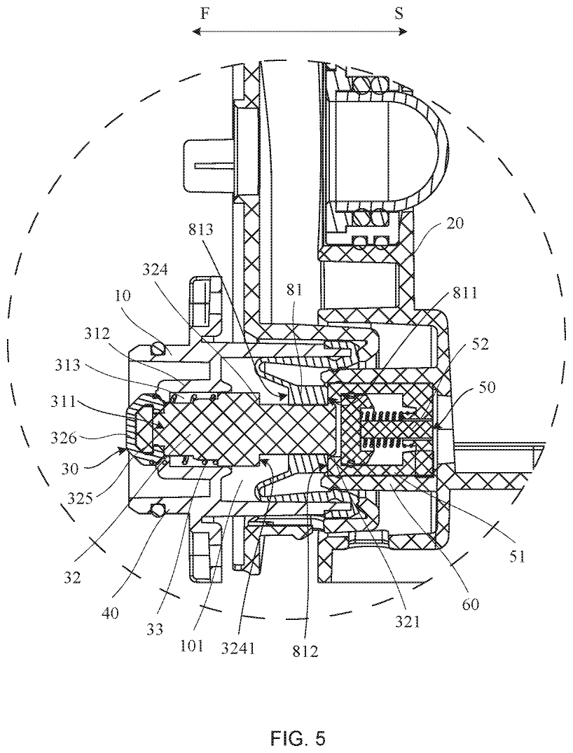

FIG. 5 is a schematic diagram illustrating a structure of a water purifier in an initial state according to some embodiments of the present disclosure. As shown in FIG. 5, in the initial state, the second valve seat 51 has just contacted the mating portion 81, but there is still a slight axial clearance (e.g., 0.2 mm to 1.0 mm) between the first valve core 32 and the second valve core 52. This means that the driving member 501 first compresses the sealing ring 80, and only thereafter does the second valve core 52 come into contact with the first valve core 32.

It can be understood that, by configuring the liquid reservoir 10 with the first connecting tube 40 in communication with the inner cavity of the liquid reservoir 10, and the liquid storage unit 20 with the second connector 60 in communication with the inner cavity of the liquid storage unit 20, with such a configuration, when the second connector 60 is inserted into the first connecting tube 40, and the first valve assembly 30 and the second valve assembly 50 are simultaneously opened, the liquid storage unit 20 may then communicate with the water storage tank via the liquid reservoir 10, thereby achieving communication between the water storage tank and the liquid storage unit 20. The above description designate the water source as the water storage tank as an example. It can be understood by those skilled in the art that the water source may also be tap water.

Furthermore, by connecting the first valve seat 31 in the first connecting tube 40, allowing the first valve core 32 to be capable of moving relative to the first valve seat 31 along the first direction F to open the valve port 311 of the first valve seat 31; and by connecting the second valve seat 51 in the second connector 60, allowing the second valve core 52 to be capable of moving relative to the second valve seat 51 toward the second direction S to open the valve port 511 of the second valve seat 51; and by configuring the setting position of the second valve core 52 to correspond to the setting position of the first valve core 32; with such a configuration, when the second connector 60 is inserted into the first connecting tube 40, the first valve assembly 30 and the second valve assembly 50 interact with each other, which can cause the second valve core 52 and the first valve core 32 to move respectively toward the second direction S and the first direction F, thereby opening the valve port 511 of the second valve seat 51 and the valve port 311 of the first valve seat 31, allowing both the second valve assembly 50 and the first valve assembly 30 to be in an open state.

On the other hand, by allowing the first valve core 32 to be capable of elastically resetting relative to the first valve seat 31 along the second direction S to close the valve port 311 of the first valve seat 31, and allowing the second valve core 52 to be capable of elastically resetting relative to the second valve seat 51 toward the first direction F to close the valve port 511 of the second valve seat 51; with such a configuration, when the second connector 60 is detached from the first connecting tube 40, both the second valve core 52 and the first valve core 32 perform elastic resetting, thereby closing both the valve port 511 of the second valve seat 51 and the valve port 311 of the first valve seat 31, allowing both the first valve assembly 30 and the second valve assembly 50 to be in a closed state.

Furthermore, by providing the sealing member 321, the sealing member 321 is configured to seal against the end surface of the mating portion 81 facing the second valve core 52, and the mating portion 81 is capable of elastically deforming relative to the first valve core 32 toward the first direction F to move or elastically resetting toward the second direction S. The setting position of the second valve seat 51 corresponds to the setting position of the mating portion 81. When the second connector 60 is inserted into the first connecting tube 40, and the second valve seat 51 just contacts the mating portion 81, there is a gap between the first valve core 32 and the second valve core 52.

With such a configuration, since an outer end portion of the sealing ring 80 is sealingly engaged with the inner wall of the first connecting tube 40, when the second connector 60 is inserted into the first connecting tube 40, and the second valve seat 51 just contacts the mating portion 81, a seal is immediately formed with the mating portion 81. At this time, there is a gap between the first valve core 32 and the second valve core 52, and the first valve core 32 and the second valve core 52 do not contact each other, thereby allowing both the first valve assembly 30 and the second valve assembly 50 to be in a closed state. As the insertion of the second connector 60 along the first direction F deepens, the mating portion 81 is pushed by the second valve seat 51 to move relative to the first valve core 32 toward the first direction F, and elastically deforms, thereby causing the second valve seat 51 and the mating portion 81 to press tightly and always maintain a sealed state. During this process, regardless of whether the first valve assembly 30 and the second valve assembly 50 are opened, the water in the first valve assembly 30 and the second valve assembly 50 cannot leak out from a boundary position between the mating portion 81 and the second valve seat 51. Therefore, no water leakage occurs during the entire insertion process of the second connector 60.

When the second connector 60 is detached from the first connecting tube 40, contrary to the above process, as the withdrawal operation of the second connector 60 along the second direction S proceeds, the second valve core 52 and the first valve core 32 may first detach from contact, thereby causing the second valve assembly 50 and the first valve assembly 30 to close respectively. On this basis, the second valve seat 51 continues to move along the second direction S, and the pressing force on the mating portion 81 gradually decreases. Until immediately before the second valve seat 51 leaves the mating portion 81, the second valve seat 51 is in an elastic resetting process, thus always pressing tightly against the mating portion 81, maintaining their sealed cooperation relationship. During this process, regardless of the order of closing of the first valve assembly 30 and the second valve assembly 50, the water in the first valve assembly 30 and the second valve assembly 50 cannot leak out from the boundary position between the mating portion 81 and the second valve seat 51 during the entire closing process of the first valve assembly 30 and the second valve assembly 50. In other words, the second valve seat 51 and the mating portion 81 may only detach from contact and release the sealed state after both the first valve assembly 30 and the second valve assembly 50 are closed. Compared with a situation in the related art where water always flows out during the closing process of the first valve assembly 30 and the second valve assembly 50, this avoids water leakage during the withdrawal process, and also greatly reduces the amount of water leakage during the entire withdrawal process of the second connector 60.

Furthermore, as shown in FIG. 3, the outer end portion of the sealing ring 80 is sealingly engaged with the inner wall of the first connecting tube 40, and the mating portion 81 at an inner end portion of the sealing ring 80 is sleeved on and in clearance fit with an outer periphery of the first valve core 32. The sealing member 321 seals against the end surface of the mating portion 81 facing the second valve core 52. In this manner, regardless of whether it is during the insertion or withdrawal process of the second connector 60, after the second valve seat 51 and the mating portion 81 detach from contact, the end surface of the mating portion 81 may cooperate with the end surface of the sealing member 321 provided on the first valve core 32 to form a seal, thereby preventing the water in the first valve assembly 30 from leaking out. Thus, it is ensured that no water leakage occurs throughout the entire withdrawal process of the second connector 60.

The clearance fit refers to that the inner diameter of the hole of the mating portion 81 is slightly larger than the outer diameter of the first valve core 32, such that a certain radial clearance (e.g., 0.05 mm to 0.3 mm on one side) exists therebetween. This fit allows the mating portion 81, when moving axially, to be guided by the first valve core 32 while avoiding seizure due to excessive frictional resistance.

The sealing member 321 is disposed at an end portion of the first valve core 32, and is configured to seal an end surface of the mating portion 81 that faces the second valve core 52.

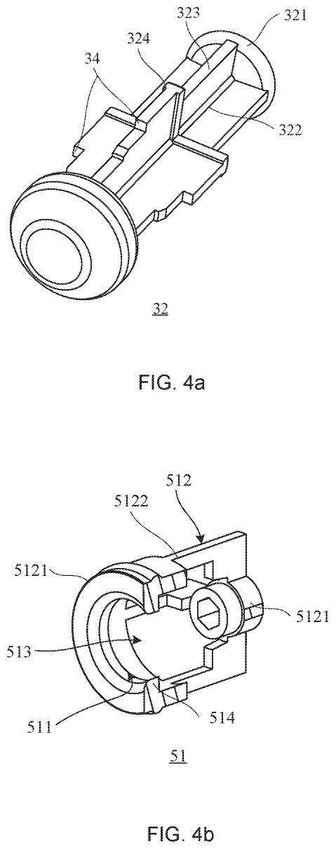

FIG. 4a is a schematic diagram illustrating a structure of a first valve core in a water purifier according to some embodiments of the present disclosure.

Referring to FIG. 4a, the first valve core 32 includes a first valve core body 322 and a plurality of first ribs 323. The plurality of first ribs 323 are arranged at intervals and around an outer peripheral surface of the first valve core body 322. The sealing member 321 is provided at an end of the first valve core body 322 away from the inner cavity of the liquid reservoir 10, and is connected to each first rib 323. In this manner, when an end surface of the sealing member 321 contacts and cooperates with an end surface of the mating portion 81, a gap between the first valve core 32 and the mating portion 81 may be completely sealed in a circumferential direction. When the mating portion 81 is subjected to a pressing force from the second valve seat 51 and moves toward the first direction F, it can quickly detach from the sealing member 321. The mating portion 81 is in clearance fit with a first rib 323, so that after the mating portion 81 detaches from the sealing member 321, a channel between the mating portion 81 and the first valve core 32 is unobstructed, thereby facilitating the water in the liquid reservoir 10 to enter and exit the first valve core 32 assembly. After the liquid reservoir 10 is connected to the liquid storage unit 20, it facilitates formation of a water flow channel between the liquid storage unit 20 and the liquid reservoir 10.

The first rib 323 refers to a strip-shaped reinforcing rib that protrudes radially outward from the outer peripheral surface of the first valve core body 322 and extends in the axial direction. For example, the first rib 323 includes a rectangular rib, an arcuate rib, or the like. The plurality of first ribs 323 are arranged at intervals around the axis of the first valve core main body 322, forming a cross-shaped or star-shaped cross-sectional profile.

In some embodiments, the first valve core body 322 and the plurality of first ribs 323 may be integrally formed or connected by any feasible means such as welding, bonding, or the like.

In some embodiments, the sealing member 321 is a disc-shaped structure (e.g., a gasket or the like) attached to an end portion of the first valve core body 322 that faces away from the inner cavity of the liquid reservoir 10, and is connected to (e.g., integrally formed with) end portions of the first ribs 323, so as to form a stable integral structure.

Further, the mating portion 81 is configured as an annular member and is sleeved over an outer peripheral side of each of the plurality of first ribs 323, and is in clearance fit with the outer peripheral side of each of the plurality of first ribs 323, with an inner diameter of the mating portion 81 being less than 7 mm.

A shape of an inner hole of the mating portion 81 matches an outer contour of rib array formed by the plurality of first ribs 323 (e.g., square, circular, or polygonal). The mating portion 81 is in line contact or narrow-surface contact with the plurality of first ribs 323, rather than surface-to-surface contact. Compared with a full-circumferential surface contact between a smooth cylindrical surface and a hole, this structure significantly reduces the sliding friction area, thereby reducing the insertion and withdrawal force.

Further, the sealing member 321 is configured as a disc-shaped structure. An outer diameter of the sealing member 321 is greater than an inner diameter of the mating portion 81. This can ensure that the sealing member 321 reliably seals the mating portion 81.

When the first valve core 32 passes through the inner hole of the mating portion 81, and the end surface of the sealing member 321 contacts the end surface of the mating portion 81, the sealing member 321 forms an “end cover” covering the opening of the inner hole of the mating portion 81. The contact line between the sealing member 321 and the mating portion 81 forms a sealing interface, thereby completely blocking the gap between the first valve core 32 and the mating portion 81 in the circumferential direction.

In some embodiments, the sealing member 321 is made of an elastic material (e.g., rubber) or is coated with a soft rubber layer on its surface. When the end surface of the sealing member 321 contacts the end surface of the mating portion 81, the sealing member 321 undergoes a slight elastic compressive deformation, filling the microscopic irregularities on the end surface of the mating portion 81 and any possible assembly perpendicularity errors, thereby ensuring that the sealing interface has no leakage path.

The plurality of first ribs 323 on the first valve core 32 can provide rigid support for the sealing member 321. The plurality of first ribs 323 securely connect the sealing member 321 to the end portion of the first valve core body 322, preventing the sealing member 321 from being turned over, warped, or collapsed when subjected to water pressure impact, thereby maintaining the flatness of the sealing interface.

In embodiments of the present disclosure, continuing to refer to FIG. 3, the sealing ring 80 includes an annular main body portion 82 and a necking portion 83. Both the necking portion 83 and the mating portion 81 are disposed around an outer side of the first valve core 32. One end of the necking portion 83 is connected to the main body portion 82, and the other end of the necking portion 83 is connected to the mating portion 81. The necking portion 83 may be configured as an elastic member. With such an arrangement, when the mating portion 81 is subjected to an external force, since the necking portion 83 is configured as an elastic member, the mating portion 81 may move relative to the first valve core 32 along the first direction F or elastically reset along the second direction S. The sealing ring 80 may be selected from materials having elastic resilience, such as rubber or silicone, or the like.

The main body portion 82 constitutes a peripheral structure of the sealing ring 80.

The necking portion 83 is a structure connecting the main body portion 82 and the mating portion 81 of the sealing ring 80. The necking portion 83 extends from an inner edge of the main body portion 82 toward the center to the mating portion 81.

The mating portion 81 is located at an innermost side of the sealing ring 80, connected to a distal end of the necking portion 83, and directly faces the first valve core 32.

The necking portion 83 forms a cantilever beam structure. One end of the necking portion 83 (at the connection to the main body portion 82) is fixed, while the other end (at the connection to the mating portion 81) is free. When the mating portion 81 is subjected to an axial force, the necking portion 83 undergoes tensile or bending deformation to absorb the stroke.

In some embodiments, the main body portion 82, the necking portion 83, and the mating portion 81 are preferably integrally formed by an injection molding process, with no seam therebetween, so as to ensure sealing integrity.

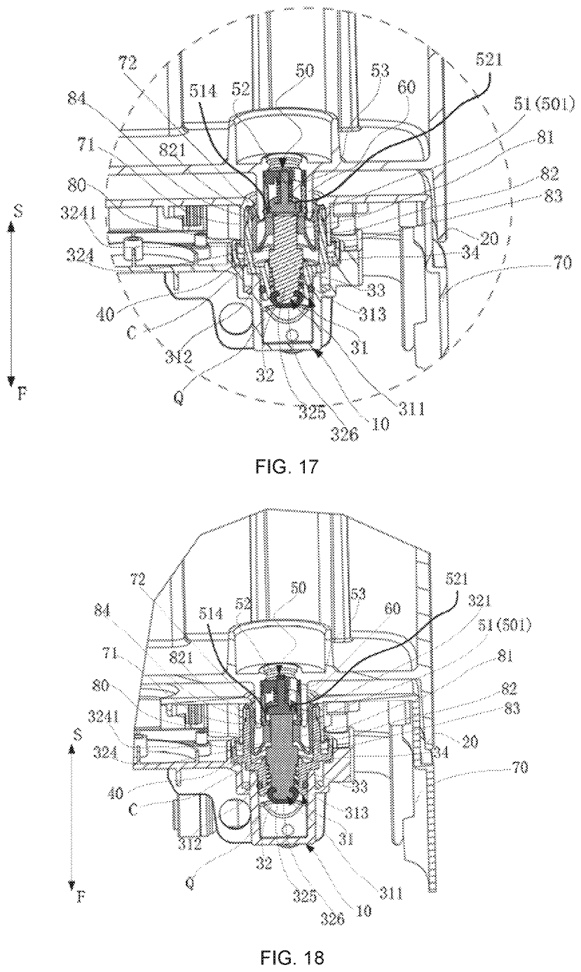

In a specific implementation, as shown in FIG. 3 and FIG. 17, both the necking portion 83 and the mating portion 81 may be located inside the main body portion 82. Alternatively, the main body portion 82, the necking portion 83, and the mating portion 81 may be arranged sequentially along the second direction S. More descriptions of FIG. 17 may be found in related descriptions below.

Further, as shown in FIG. 3, an end of the main body portion 82 away from the necking portion 83 is provided with a first flanging portion 84 that is folded outward, a peripheral surface of the main body portion 82 presses against an inner wall of the first connecting tube 40, and the first flanging portion 84 is sleeved on an end of the first connecting tube 40 away from the liquid reservoir 10. In this way, a good seal is formed between the first flanging portion 84 and the inner wall of the first connecting tube 40, and additionally, the sealing ring 80 may be installed on the first connecting tube 40 through a mounting space formed between the first flanging portion 84 and the main body portion 82.

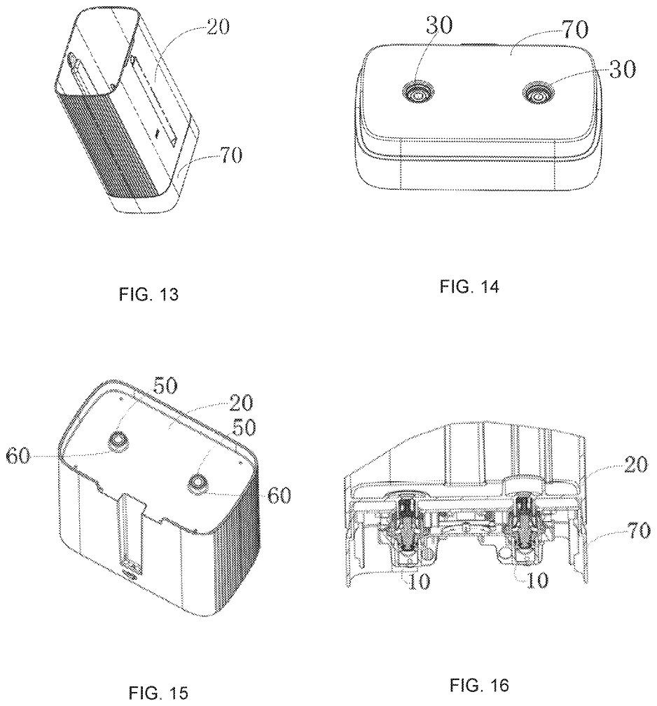

Further, referring to FIG. 1, FIG. 2, FIG. 3, FIG. 13, FIG. 16, and FIG. 17, the water purifier 100 further includes a housing 70, the liquid reservoir 10 is connected to the housing 70, the housing 70 is provided with a connecting pipe 71 through which the first connecting tube 40 is inserted, an end of the connecting pipe 71 is provided with a second flanging portion 72 that is folded inward, and the second flanging portion 72 presses the first flanging portion 84 tightly against the end of the first connecting tube 40 away from the liquid reservoir 10. With such an arrangement, the second flanging portion 72 may press against an outer side of the first flanging portion 84, thereby pressing the first flanging portion 84 tightly against the end of the first connecting tube 40. More descriptions of FIGS. 16 and 17 may be found in related descriptions below.

The first flanging portion 84 and the second flanging portion 72 are axial anti-withdrawal structures of the sealing ring 80. The first flanging portion 84 is a structure on the sealing ring 80, and the second flanging portion 72 is a structure on the housing 70. The two cooperate with each other to prevent the sealing ring 80 from being forced out by water pressure or being carried out during withdrawal.

For example, the first flanging portion 84 is an outward-turned flanging structure at an end portion of the main body portion 82 facing away from the necking portion 83, and the second flanging portion 72 is an inward-turned flanging structure at an end portion of the connecting tube 71 proximate to the second connector 60. The second flanging portion 72 can press the first flanging portion 84 tightly against the end surface of the first connecting tube 40 to secure it. It should be noted that “outward-turned” as used herein refers to a direction away from the inner cavity of the first connecting tube 40, while “inward-turned” refers to a direction toward the interior of the connecting tube 71.

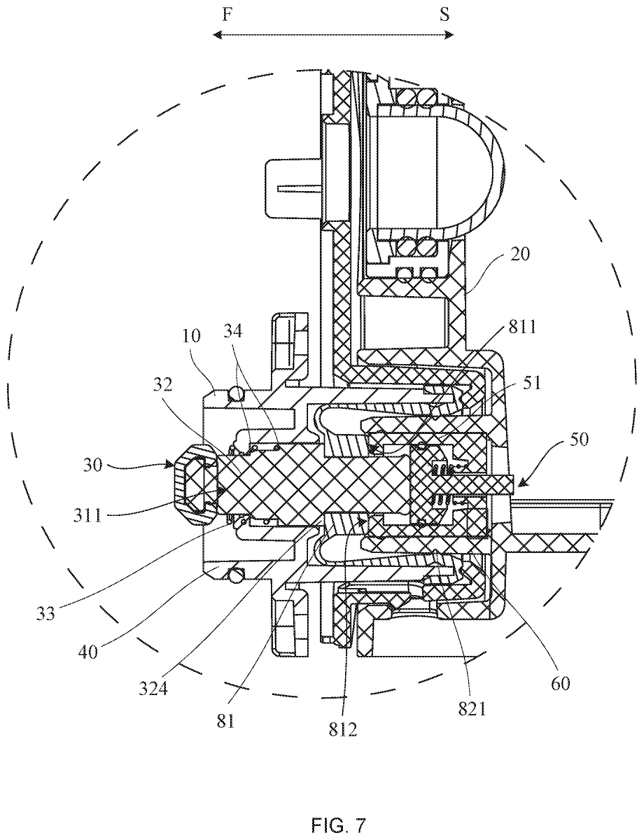

It should be noted that the phrase ‘the first valve assembly 30 includes the first valve core 32 and the sealing ring 80 located in the first connecting tube 40’ refers to at least a portion of the first valve core 32 and the sealing ring 80 being located in the first connecting tube 40, rather than merely referring to a case where the first valve core 32 and the sealing ring 80 are completely located in the first valve assembly 30. For example, in FIG. 7, the sealing ring 80 also includes a portion located outside the first connecting tube 40.

In an embodiment of the present disclosure, continuing to refer to FIG. 3 and FIG. 17, an inner diameter of the mating portion 81 is less than or equal to an inner diameter of the second valve seat 51, and projections of surfaces of the mating portion 81 and the second valve seat 51 facing each other on a plane perpendicular to the first direction F have an overlapping portion. With such an arrangement, it facilitates the second valve seat 51 to smoothly press against the mating portion 81 and move along the first direction F.

Further, an outer diameter of the second connector 60 is less than an inner diameter of the main body portion 82, an annular protruding portion 821 is provided inside the main body portion 82, and when the second connector 60 is inserted into the first connecting tube 40, the protruding portion 821 presses against an outer wall of the second connector 60. With such an arrangement, it also facilitates the second connector 60 to be smoothly inserted into the first connecting tube 40. The protruding portion 821 presses against the outer wall of the second connector 60, on the one hand, making the insertion operation more tactile, and on the other hand, facilitating the formation of a seal between the second connector 60 and the sealing ring 80, thereby preventing the second connector 60 from withdrawing from the first connecting tube 40.

The protruding portion 821 refers to a localized protruding structure that projects radially inward from the inner wall of the main body portion 82, and its cross-sectional shape may be semicircular, triangular, rectangular, or trapezoidal.

When the second connector 60 is inserted into the first connecting tube 40, the protruding portion 821 is squeezed and elastically deforms, applying a radial gripping force to the outer wall of the second connector 60, thereby forming a radial seal to prevent water from leaking outward along the gap therebetween.

In some embodiments, an outer portion of the second connector 60 is further provided with a groove cooperating with the protruding portion 821. The protruding portion 821 can engage with the groove on the outer wall of the second connector 60, so as to limit axial movement of the second connector 60 and prevent accidental disengagement.

During insertion of the second connector 60 into the first connecting tube 40 and after it is in place, the tubular outer wall of the second connector 60 is clamped or surrounded by the inner side wall (the mating portion 81) and the outer side wall (the main body portion 82) of the sealing ring 80.

In an embodiment of the present disclosure, referring to FIG. 5, surfaces of the mating portion 81 and the second valve seat 51 facing each other are respectively designated as a first surface 811 and a second surface 812. The first surface 811 is an end surface of the mating portion 81 facing the second valve seat 51 (i.e., a driven surface); the second surface 812 is an end surface of the second valve seat 51 facing the mating portion 81 (i.e., a driving surface).

In the initial state, as shown in FIG. 5, an end of the first valve core 32 away from the inner cavity Q of the liquid reservoir 10 protrudes beyond the first surface 811, and a distance D1 between an end surface of the first valve core 32 facing the second valve core 52 and the first surface 811 and a distance D2 between an end surface of the second valve core 52 facing the first valve core 32 and the second surface 812 satisfy: D1<D2. With such an arrangement, it facilitates that when the first surface 811 and the second surface 812 contact each other, there is still a gap between the first valve core 32 and the second valve core 52, ensuring that when the second connector 60 is inserted, the mating portion 81 and the second valve seat 51 first contact each other to form a seal, and then open the first valve assembly 30 and the second valve assembly 50; meanwhile, when the second connector 60 is withdrawn, after both the first valve assembly 30 and the second valve assembly 50 are closed, the mating portion 81 and the second valve seat 51 detach from each other.

The end of the first valve core 32 facing away from the interior cavity of the liquid reservoir 10 (hereinafter referred to as the front end of the first valve core 32) refers to the end of the first valve core 32 that faces the second connector 60 in the axial direction, and this end is the foremost point of the first valve core 32 in the second direction S. The front end of the first valve core 32 protrudes beyond the first surface 811, that is, the foremost point of the first valve core 32 in the second direction S axially exceeds the first surface 811, meaning that the front end of the first valve core 32 is closer to the second connector 60 than the first surface 811 is.

The end face of the second valve core 52 facing the first valve core 32 (hereinafter referred to as the front end of the second valve core 52) refers to the end of the second valve core 52 that faces the first connecting tube 40 in the axial direction. The second surface 812 protrudes beyond the front end of the second valve core 52, that is, the second surface 812 axially exceeds the foremost point of the second valve core 52 in the first direction F, meaning that the second surface 812 is closer to the first connecting tube 40 than the front end of the second valve core 52 is.

Further, an end surface of the mating portion 81 away from the first surface 811 is designated as a third surface 813. Referring to FIG. 4a and FIG. 5, a first step portion 324 that is locally protruding is provided between two ends of the first valve core 32, and the first step portion 324 is configured to block a moving path of the mating portion 81 along the first direction F. The first stepped portion 324 refers to a locally protruding structure on the first valve core 32 (e.g., an annular boss or a unilateral projection) for axial positioning/limitation.

The first step portion 324 includes a first step surface 3241 extending radially along the first valve core 32, and the first step surface 3241 is arranged opposite to the third surface 813. A distance D3 between the end surface of the first valve core 32 facing the second valve core 52 and the first step surface 3241 and a thickness dimension D4 of the mating portion 81 along the first direction F satisfy: D3>D4.

With such an arrangement, during insertion of the second connector 60, after the second valve seat 51 contacts the sealing ring 80, as the sealing ring 80 is pressed and deformed, and after the second valve core 52 contacts the first valve core 32, the second valve core 52 is opened. As the second connector 60 is further inserted, the second valve seat 51 may press against the mating portion 81 and move relative to the first valve core 32 along the first direction F, until the third surface 813 contacts the first step surface 3241. The second valve seat 51 continues to move forward along the first direction F by pressing against the first step portion 324 through the mating portion 81, pushing the first valve core 32 to move along the first direction F, thereby opening the valve port 311 of the first valve seat.

Further, as shown in FIG. 5, the first valve seat 31 includes a first valve seat body 312, the first valve seat body 312 is configured with a first accommodation chamber 313 with openings at both ends, and an opening of the first accommodation chamber facing the inner cavity of the liquid reservoir 10 forms the valve port 311 of the first valve seat. The first valve core 32 passes through the first accommodation chamber 313 and is in guiding cooperation with a wall of the first accommodation chamber 313, and a first sealing end 325 of the first valve core 32 enters the inner cavity of the liquid reservoir 10 through the valve port 311 of the first valve seat. A first valve core sealing member 326 may also be provided on the first sealing end 325 of the first valve core 32, configured to form a sealing cooperation with the valve port 311 of the first valve seat when contacting the valve port 311 of the first valve seat.

The first valve seat body 312 is a base body of the first valve assembly 30, fixed within the first connecting tube 40 of the liquid reservoir 10, and serves to provide support and guidance. The first accommodation chamber 313 is a hollow cavity inside the first valve seat body 312, with openings at both ends, and is used to accommodate the first valve core 32. The rear end of the first accommodation chamber 313 facing the liquid reservoir 10 forms the valve port 311 of the first valve seat 31, and the front end of the first accommodation chamber 313 facing the second connector 60 is used for the first valve core 32 to pass out therethrough.

The first valve core 32 extends through the first accommodation chamber 313, with its tail end (the first sealing end 325) passing through the valve port 311 and extending into the interior of the first accommodation chamber 313; its head end (the end opposite to the first sealing end 325) is located at the front end of the first accommodation chamber 313 or outside thereof, for receiving the thrust from the second valve assembly 50. The first sealing end 325 is the end of the first valve core 32 facing the interior cavity of the liquid reservoir 10, and is used to block or open the valve port 311.

The clearance fit or sliding fit is adopted between the outer wall of the first valve core 32 and the cavity wall of the first accommodation chamber 313. For example, the cavity wall of the first accommodation chamber 313 may be polished or provided with guide ribs to ensure that the first valve core 32 does not get stuck or undergo radial deflection when subjected to axial thrust, and always moves along the axis.

When the second connector 60 is inserted into the first connecting tube 40, and the second valve core 52 pushes the first valve core 32 to move in the first direction F, the first sealing end 325 disengages from the valve port 311, and the interior cavity of the liquid reservoir 10 is communicated with the accommodating space C through the first accommodation chamber 313.

When the second connector 60 is withdrawn from the first connecting tube 40, the first valve core 32 is pushed in the second direction S under the action of the first elastic member 33, and the first sealing end 325 blocks the valve port 311, cutting off the flow passage.

Further, the first valve assembly 30 further includes a first elastic member 33, the first elastic member 33 is disposed between an inner wall of the first valve seat 31 and the first valve core 32, and is configured to always apply an elastic force toward the second direction S to the first valve core 32, which allows for the elastic resetting of the first valve core 32.

Further, combined with FIG. 3 and FIG. 4A, an outer surface of the first valve core 32 is provided with at least one second step portion 34, and two ends of the first elastic member 33 press between an inner wall of the first valve seat 31 and the at least one second step portion 34, respectively. In this way, the first elastic member 33 thereby facilitates simple positioning by being sleeved on the first valve core 32 and having two ends pressing between the inner wall of the first valve seat 31 and the second step portion 34, respectively.

The second step portion 34 is an annular or partial platform locally protruding from the outer surface of the first valve core 32, serving as the force application point for the first elastic member 33.

The first elastic member 33, through compressive deformation, applies an elastic force to the second step portion 34 in the direction toward the second direction S. This ensures that, when no external force is inserted, the first valve core 32 can automatically and reliably remain in the closed state.

FIG. 4b is a schematic diagram illustrating a structure of a second valve seat in a water purifier according to some embodiments of the present disclosure. Further, combined with FIG. 3 and FIG. 4B, the second valve seat 51 includes a second valve seat body 512, and the second valve seat body 512 is configured with a second accommodation chamber 513 with openings at both ends, and an opening of the second accommodation chamber 513 away from the inner cavity of the liquid storage unit 20, i.e., an opening facing the first valve seat 31, forms the valve port 511 of the second valve seat 51.

The second valve seat body 512 is a base body of the second valve assembly 50, typically installed within the second connector 60, and serves as the motion track and supporting base for the second valve core 52.

The second accommodation chamber 513 is a hollow cavity inside the second valve seat body 512, used to accommodate the second valve core 52 and provide axial movement space. The front end of the second accommodation chamber 513 facing the liquid reservoir 10 (or the end facing away from the liquid storage unit 20) forms the valve port 511 of the second valve seat 51.

The second sealing end 521 is the end of the second valve core 52 facing the first connecting tube 40, and its structural design matches the valve port 511 for blocking or opening the valve port 511.

In a specific implementation, as shown in FIG. 4b, the second valve seat body 512 may include two bases 5121 and a plurality of connecting ribs 5122 connected between the two bases 5121. In FIG. 3, a cutting position of a cross-section is located between two adjacent connecting ribs 5122; therefore, the connecting ribs 5122 are not shown in FIG. 3.

The second valve core 52 passes through the second accommodation chamber 513 and is in guiding cooperation with a wall of the second accommodation chamber 513, and when a second sealing end 521 of the second valve core 52 moves along the first direction F, the second sealing end 521 seals the valve port 511 of the second valve seat. For example, the inner wall of the second valve seat body 512 is designed with guide ribs or smooth surfaces to ensure that the second valve core 52 does not deflect during movement, and that the second sealing end 521 can be accurately aligned with the valve port 511.

When the second connector 60 is inserted into the first connecting tube 40, the second valve core 52 is subjected to the reaction force from the first valve core 32 or the first valve seat 31, and moves in the second direction S (i.e., toward the inner side of the liquid storage unit 20). At this time, the second sealing end 521 moves away from the valve port 511 and opens the orifice, communicating with an outlet channel of the liquid storage unit 20.

When the second connector 60 is withdrawn from the first connecting tube 40, the second valve core 52 is reset in the first direction F (i.e., toward the side of the first connecting tube 40) under the action of the second elastic member 53, and the second sealing end 521 seals the valve port 511, so that water inside the liquid storage unit 20 cannot flow out.

In some embodiments, as shown in FIG. 4b, an edge of the valve port 511 of the second valve seat is provided with a third flanging portion 514 that is folded inward, and the third flanging portion 514 is configured to stop and cooperate with the second sealing end 521 of the second valve core 52. The third flanging portion 514 refers to an annular flange formed by turning or contracting the edge of the valve port 511 of the second valve seat 51 inward (toward the second accommodation chamber 513). The third flanging portion 514 is used to limit the extreme position of the second valve core 52 moving in the first direction F, and serves as a support point for the second elastic member 53.

In some embodiments of the present disclosure, as shown in FIG. 3, the second valve assembly 50 further includes a second elastic member 53, the second elastic member 53 is disposed between an inner wall of the second valve seat 51 and the second sealing end 521 of the second valve core 52, and is configured to always apply an elastic force in the first direction F to the second valve core 52, which allows for the elastic resetting of the second valve core 52.

Additionally, regarding the installation of the second connector 60, referring to FIG. 2, an outer wall of the liquid storage unit 20 is configured with a mounting chamber 91 in communication with the inner cavity of the liquid storage unit 20, and the second connector 60 is installed in the mounting chamber 91. Of course, a clearance chamber 92 is also provided outside the mounting chamber 91 to facilitate accommodating the first connecting tube 40.

In some other embodiments, the first valve core 32 includes a first sealing end 325 and an opposite end disposed opposite to the first sealing end 325. When the liquid storage unit 20 is mounted on the liquid reservoir 10, the mating portion 81 is located between the opposite end and the first sealing end 325, the first valve assembly 30 is opened, the first sealing end 325 is opened, and the interior cavity of the liquid reservoir 10 is communicated with the accommodating space C; the sealing member 321 is provided on the opposite end of the first valve core 32, and the sealing member 321 is used for sealing engagement with the mating portion 81; when the liquid storage unit 20 is not mounted on the liquid reservoir 10, the second connector 60 is disengaged from the first connecting tube 40, and the sealing member 321 is in sealing engagement with the mating portion 81.

When the liquid storage unit 20 is mounted, the mating portion 81 is located between the opposite end and the first sealing end 325 (i.e., within the guide section), ensuring that when the first valve core 32 moves in the first direction F, the mating portion 81 is not blocked by the first sealing end 325; when the liquid storage unit 20 is not mounted, the mating portion 81 resets to the end surface of the opposite end and is completely fitted with the sealing member 321. In this way, the problem in conventional structures of “sealing failure due to unclear positioning of the mating portion” is solved, and the determinacy of sealing and on/off switching during the insertion and withdrawal process is ensured through axial zoning.

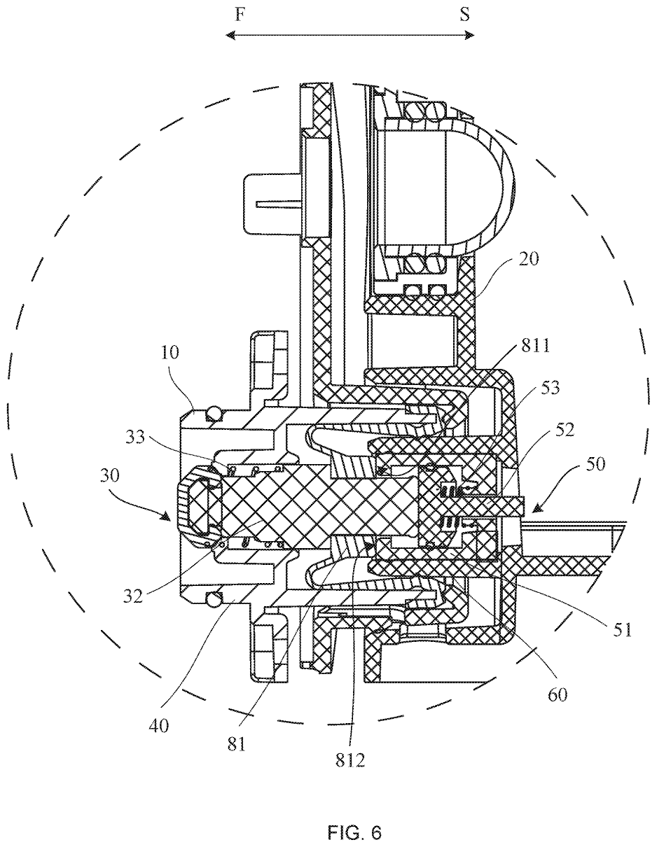

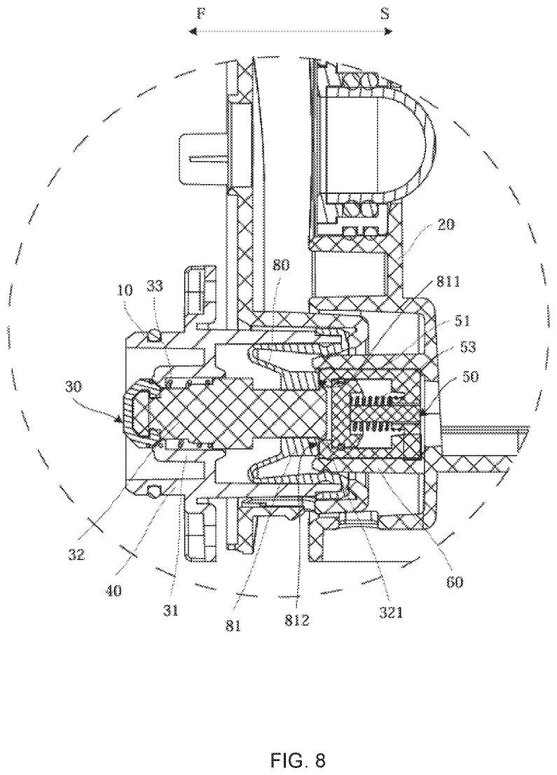

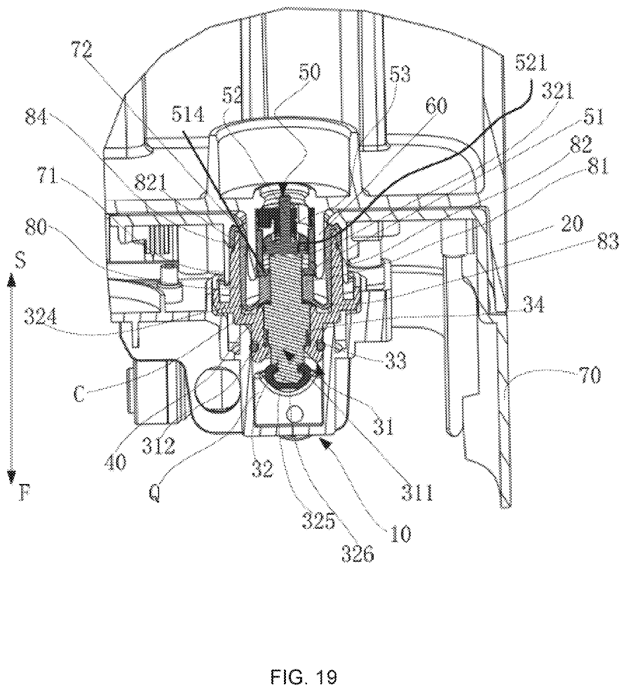

FIG. 6 is a schematic diagram illustrating a structure of a water purifier in a first state according to an embodiment of the present disclosure. FIG. 7 is a schematic diagram illustrating a structure of a water purifier in a second state according to an embodiment of the present disclosure. FIG. 8 is a schematic diagram illustrating a structure of a water purifier in a third state according to an embodiment of the present disclosure. FIG. 17 is a schematic diagram illustrating a structure of a water purifier in an initial state according to other embodiments of the present disclosure. FIG. 18 is a schematic diagram illustrating a structure of a water purifier in a second state according to other embodiments of the present disclosure. FIG. 19 is a schematic diagram illustrating a structure of a water purifier in a third state according to other embodiments of the present disclosure. More descriptions of FIGS. 17-19 may be found in related descriptions below.

Hereinafter, the insertion and withdrawal process of the liquid storage unit 20 and the liquid reservoir 10 in the water purifier 100 according to an embodiment of the present disclosure will be described with reference to FIG. 3, FIG. 5, FIG. 6, FIG. 7, and FIG. 8.

FIG. 3 illustrates a schematic diagram of the second connector 60 just inserted into the first connecting tube 40, and at this time, both the first valve assembly 30 and the second valve assembly 50 are in a closed state. The sealing member 321 seals against the end surface of the mating portion 81, therefore, neither the side of the first valve assembly 30 nor the side of the second valve assembly 50 will leak water.

FIG. 5 (FIG. 17) shows the initial state, at this time, both the first valve assembly 30 and the second valve assembly 50 are still in a closed state; the second surface 812 of the second valve seat 51 just contacts the first surface 811 of the mating portion 81; at this time, there is a gap between the first valve core 32 and the second valve core 52, and they are not in contact, and the second surface 812 of the second valve seat 51 and the first surface 811 of the mating portion 81 contact each other to form a seal. The sealing member 321 seals against the end surface of the mating portion 81, and water cannot leak out from either the first valve assembly 30 or the second valve assembly 50.

Referring to FIG. 6 (FIG. 18), when the second connector 60 is further inserted into the first connecting tube 40 along the first direction F, the first valve core 32 and the second valve core 52 contact each other, and since an elastic coefficient of the first elastic member 33 is greater than an elastic coefficient of the second elastic member 53, the second valve core 52 is pushed open by the first valve core 32, thereby opening the second valve assembly 50, and placing the water purifier 100 in a first state. During this process, since the second surface 812 of the second valve seat 51 and the first surface 811 of the mating portion 81 always contact each other to form a seal, water may not leak out from between the second valve seat 51 and the mating portion 81.

Referring to FIG. 7 (FIG. 19), when the second connector 60 is further inserted into the first connecting tube 40 along the first direction F, the second valve seat 51 drives the mating portion 81 to move along the first direction F, while causing an elastic deformation of the mating portion 81 and causing the mating portion 81 to press against the first step portion 324, and driving the first valve core 32 to also move along the first direction F, overcoming the elastic force of the first elastic member 33, thereby pushing open the first valve core 32, thereby also opening the first valve assembly 30, and placing the water purifier 100 in a second state. At this time, both the first valve assembly 30 and the second valve assembly 50 are open, thereby realizing water flow between the liquid storage unit 20 and the liquid reservoir 10. In the position of FIG. 7, the second step portion 34 on the first valve core 32 presses against a periphery of the valve port 311 of the first valve seat, thereby preventing the first valve seat 31 from continuing to move toward the F.

It can be understood that, since the second surface 812 of the second valve seat 51 and the first surface 811 of the mating portion 81 always contact each other to form the seal, water may not leak out from between the second valve seat 51 and the mating portion 81. During this process, an outer wall of the second connector 60 and the protruding portion 821 always have an interference fit, which can prevent the second connector 60 from being pulled out of the first connecting tube 40 toward the S, and further prevent water from leaking out.

Referring to FIG. 8, when the liquid storage unit 20 is pulled out, as the second valve seat 51 is withdrawn along the S, the first elastic member 33 elastically resets, and the first valve core 32 gradually moves toward the S, firstly closing the first valve assembly 30. At this time, after the third surface 813 of the mating portion 81 detaches from the second step portion 34, the second valve seat 51 no longer applies pressing pressure to the first valve core 32 through the mating portion 81.

In addition, the second connector 60 continues to be withdrawn. Due to the absence of the pressing pressure from the second valve seat 51, the mating portion 81 also gradually elastically resets. During this process, the second elastic member 53 also gradually elastically resets to close the second valve assembly 50. After the second valve assembly 50 is completely closed, the second connector 60 continues to be withdrawn. During this process, the first surface 811 of the mating portion 81 and the second surface 812 of the second valve seat 51 always remain in sealed contact, thereby preventing water leakage, and causing the water purifier 100 to be in a third state as shown in FIG. 8. Of course, during this process, since an outer diameter of the sealing member 321 is 8.0 mm and the inner diameter of the mating portion 81 is 7.3 mm, during the resetting process of the mating portion 81, the sealing member 321 eventually presses against the first surface 811 of the mating portion 81, thereby achieving the effect of no water leakage when the liquid storage unit 20 is pulled out. At this time, the water on a side of the first valve assembly 30 is all stored in a space defined by the sealing ring 80 and the first valve seat 31, and will not leak out. When the liquid storage unit 20 continues to be pulled out, the mating portion 81 and the second valve seat 51 detach from each other, and the state shown in FIG. 3 can be returned to.

FIGS. 17-19 also illustrate an insertion and withdrawal process of the liquid storage unit 20 and the liquid reservoir 10, the working principle of which is the same as the above-described process, and therefore will not be described again in the present disclosure.

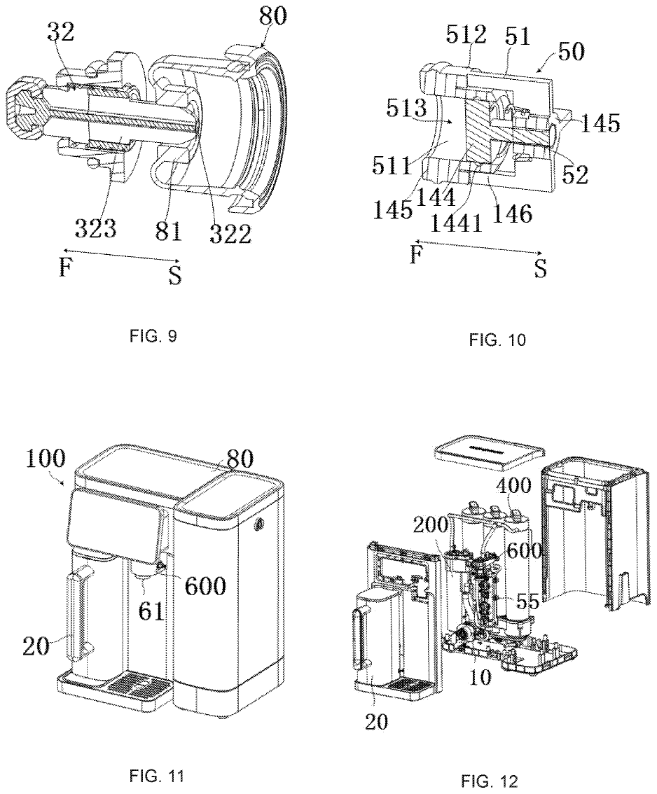

FIG. 9 is a schematic diagram illustrating another structure of a first valve assembly in a water purifier according to some embodiments of the present disclosure, and FIG. 10 is a schematic diagram illustrating another structure of a second valve assembly in the water purifier according to some embodiments of the present disclosure.

Referring to FIGS. 9 and 10, based on the above-described embodiment, the structures of the first valve assembly 30 and the second valve assembly 50 are further improved, and other structures are similar to those previously described, and therefore will not be described again herein.

Specifically, the first valve core 32 includes a first valve core body 322 and a plurality of first ribs 323, and the plurality of first ribs 323 are arranged at intervals and around an outer peripheral surface of the first valve core body 322. As described above, when the mating portion 81 is configured as an annular member, the mating portion 81 is sleeved on an outer peripheral side of each first rib 323 and is in clearance fit with the outer peripheral side of each first rib 323, and an inner diameter of the mating portion 81 is less than 7 mm.

Such a configuration may form a sealing water film between an inner wall of the mating portion 81 and the first valve core 32 (which forms a cross-shaped section). Thus configured, since an outer end of the sealing ring 80 sealingly cooperates with an inner wall of the first connecting tube 40, and the sealing water film is formed between the mating portion 81 at an inner end of the sealing ring 80 and the first valve core 32, such that, regardless of the insertion or withdrawal process of the second connector 60, after the second valve seat 51 and the mating portion 81 detach from each other, the mating portion 81 will always form a seal with the first valve core 32, preventing water from leaking out of the first valve assembly 30, thereby ensuring that no water leakage occurs throughout the entire withdrawal process of the second connector 60.

In addition, referring continually to FIG. 10, the second valve seat 51 includes a second valve seat body 512, the second valve seat body 512 is configured with a second accommodation chamber 513 with openings at both ends, and an opening of the second accommodation chamber 513 away from the inner cavity of the liquid storage unit 20 forms the valve port 511 of the second valve seat.

The second valve core 52 passes through the second accommodation chamber 513 and is in guiding cooperation with a wall of the second accommodation chamber 513, and when the second sealing end 521 of the second valve core 52 moves along the first direction F, the second sealing end 521 seals the valve port 511 of the second valve seat. An annular protruding portion 1441 is provided on an outer side of the second sealing end 521, and when the second valve core 52 moves such that the annular protruding portion 1441 is located outside a wall of the valve port 511 of the second valve seat, the second valve assembly 50 is opened. The liquid storage unit sealing end 144 refers to the above-described second sealing end 521.

In a specific implementation, the second valve seat body 512 may include two bases 145 and a plurality of connecting ribs 146 connected between the two bases 145. Between the bases 145 and the plurality of connecting ribs 146, the second accommodation chamber 513 is defined.

In an embodiment of the present disclosure, the liquid reservoir 10 is a communicating vessel, and the liquid storage unit 20 is a clean water tank; or, the liquid reservoir 10 is a raw water tank base, and the liquid storage unit 20 is a raw water tank; or, the liquid reservoir 10 is a raw water tank, and the liquid storage unit 20 is a raw water tank base.

FIG. 11 is a schematic diagram illustrating a structure of a water purifier according to an embodiment of the present disclosure, and FIG. 12 is another schematic diagram illustrating a structure of a water purifier according to some embodiments of the present disclosure FIGS. 1-12 illustrate embodiments in which the liquid reservoir 10 is a communicating vessel and the liquid storage unit 20 is a clean water tank. Referring continually to FIGS. 11 and 12, embodiments of the present disclosure provides a water purifier 100 configured to purify water from a to-be-filtered water source.

The water purifier 100 further includes: a housing; a filter; a level box 200; a water pump; a heater 55; and a water vapor separator 600. The filter is in communication with the inner cavity C of the communicating vessel, the communicating vessel is respectively in communication with the clean water tank and the level box 200, and the water pump is respectively in communication with the inner cavity C of the communicating vessel and the heater, thereby allowing the water pump to draw water from the level box 200 and the clean water tank through the communicating vessel to the heater. The heater is in communication with the water vapor separator 600. It should be noted that the communicating vessel and the clean water tank are detachably connected.

Thus configured, when a user takes water, the water pump draws water from the communicating vessel, and water in the level box 200 and the clean water tank simultaneously flows into the water pump through the communicating vessel. The water from the water pump flows into the heater 55, and after being heated by the heater 55, flows into the water vapor separator 600, and then flows out from the water vapor separator 600.

The filter is configured to connect with the to-be-purified water source, so as to facilitate filtering the to-be-purified water source. The clean water tank is configured to store filtered clean water. A water level sensor 12 is provided in the level box 200, the clean water tank 20 is in communication with the level box 200 through the communicating vessel, and both the clean water tank 20 and the level box 200 are in communication with the atmosphere. According to the principle of the communicating vessel, the water level in the level box 200 can reflect a water level in the clean water tank 20.

The heater is configured to heat clean water, the water vapor separator 600 is configured to separate water vapor from heated clean water, a water vapor separation outlet 61 is provided on the water vapor separator 600, and the water vapor separation outlet 61 forms a water outlet of the water purifier 100.

When a user needs to take clean water, the water pump operates, and simultaneously draws water from the clean water tank and the level box into the heater through the communicating vessel. After passing through the heater, and then continually passing through the water vapor separator 600, it is taken out from the water vapor separation outlet 61.

When the water level in the level box 200 is lower than the high water level described below, the filter 400 operates to purify a to-be-purified water source, and purified water enters the level box 200 and the clean water tank respectively through the communicating vessel.

The water level sensor is provided in the level box 200. Merely by way of example, the water level sensor is configured as a float sensor, and the water level sensor includes a first float and a second float. The first float and the second float are respectively configured to detect whether a water level reaches a high water level or a low water level. Of course, in other embodiments, the water level sensor may include only one float, and use this float to detect whether the water level reaches the high water level or the low water level. The above-described detection manners of a dual-float or single-float are conventional technical means in the art, and therefore will not be described again in the present disclosure. Of course, other manners for detecting the high water level or the low water level may also be used, for example, by utilizing an optical sensor, and the present disclosure does not specifically limit this.

In an embodiment of the present disclosure, the water purifier 100 further includes a controller (not shown). The controller is electrically connected to the water level sensor and the booster pump. The controller is configured to control the booster pump to stop operating, thereby stopping water production, when a liquid level in the level box 200 is at a high liquid level; to control the booster pump to start operating to produce water when the liquid level in the level box 200 is below the high liquid level; and to control the water pump to stop operating to stop water discharge when the liquid level in the level box 200 is at a low liquid level.

FIG. 13 is a schematic diagram illustrating a structure of a liquid reservoir and a liquid storage unit cooperating with each other in a water purifier according to other embodiments of the present disclosure; FIG. 14 is a schematic diagram illustrating a partial structure of a water purifier according to other embodiments of the present disclosure; FIG. 15 is a schematic diagram illustrating a structure of a liquid storage unit according to other embodiments of the present disclosure; FIG. 16 is a schematic diagram illustrating a cross-sectional structure of a water purifier according to other embodiments of the present disclosure.

FIGS. 13-19 illustrate embodiments in which the liquid reservoir 10 is a raw water tank base and the liquid storage unit 20 is a raw water tank. In FIGS. 13-19, elements with the same reference numerals as those in the above-described FIGS. 1-8 have the same or similar structures, and therefore will not be described again in the present disclosure. In this embodiment, the raw water tank base is configured to provide raw water from the raw water tank to the filter. In practical application, the raw water from the raw water tank is provided to a booster pump via the raw water tank base, and is provided to the filter via the booster pump for filtering. The raw water tank base may also be configured to provide filtered concentrated water to the raw water tank.

In FIGS. 13-19, embodiments in which the raw water tank and the raw water tank base respectively include two water passages is illustrated, wherein one water passage is a raw water inlet, and the other water passage is a concentrated water outlet. Of course, in other embodiments of the present disclosure, the raw water tank and the raw water tank base may also include only one water passage, which serves as the raw water inlet to provide raw water to the entire machine. In FIGS. 13-15, embodiments in which structures of the two water passages are the same is illustrated, and in other embodiments of the present disclosure, the structure to be protected by the present disclosure may also be used for one water passage.

The technical features of the above-described embodiments may be arbitrarily combined. To simplify the description, not all possible combinations of the various technical features in the above-described embodiments have been described, however, as long as combinations of these technical features do not conflict, they should all be considered within the scope of the present disclosure.

The above-described embodiments merely express several implementations of the present disclosure, and their descriptions are relatively specific and detailed, but should not therefore be understood as a limitation on the scope of the patent application. It should be noted that, for a person of ordinary skill in the art, several variations and improvements may also be made without departing from the inventive concept of the present disclosure, and these all fall within the protection scope of the present disclosure. Accordingly, a scope of protection for the present disclosure shall be defined by the appended claims.

What is claimed is:

1. A water purifier, comprising: a liquid reservoir, a first valve assembly, and a liquid storage unit; wherein
the liquid reservoir is provided with a first connecting tube in communication with an inner cavity of the liquid reservoir; the liquid storage unit is provided with a second connector in communication with an inner cavity of the liquid storage unit;
the first valve assembly includes a first valve core and a sealing ring located in the first connecting tube, the first valve core is configured to open or close the first valve assembly while the second connector is inserted into or pulled out of the first connecting tube;
one end of the sealing ring is sealingly engaged with the first connecting tube, and the other end of the sealing ring is provided with a mating portion, the mating portion is movably sleeved on the first valve core, the first connecting tube, the first valve core, and the sealing ring together form an accommodating space (C), and the accommodating space (C) is in communication with the inner cavity of the liquid reservoir when the first valve assembly is open.

2. The water purifier according to claim 1, wherein the first valve core is provided with a sealing member, and the sealing member is configured to sealingly engage with the mating portion;
the water purifier further includes a second valve assembly provided in the second connector;
the second valve assembly includes a driving member, and when the second connector is detached from the first connecting tube, the sealing member sealingly engages with the mating portion;
when the second connector is inserted into the first connecting tube, the driving member presses against and drives the mating portion to detach from the sealing member, so that the second connector is in communication with the inner cavity of the liquid reservoir via the accommodating space (C).

3. The water purifier according to claim 2, wherein the sealing ring is an elastic member, the mating portion is capable of moving along a first direction (F) under driving of the driving member, or elastically resetting along a second direction(S) opposite to the first direction (F), so that a volume of the accommodating space (C) becomes smaller or larger, and the first direction (F) is an insertion direction in which the second connector is inserted into the first connecting tube.

4. The water purifier according to claim 2, wherein the second valve assembly includes a second valve seat and a second valve core passing through the second valve seat, the second valve seat is connected in the second connector, the second valve core is capable of moving relative to the second connector toward the second direction(S), or elastically resetting toward the first direction (F) opposite to the second direction(S), to open or close a valve port of the second valve seat; the second valve seat forms the driving member;
the second direction(S) is a withdrawal direction in which the second connector is pulled out relative to the first connecting tube.

5. The water purifier according to claim 4, wherein a setting position of the second valve seat corresponds to a setting position of the mating portion, a setting position of the second valve core corresponds to a setting position of the first valve core;
a state where the second connector is located in the first connecting tube and the second valve seat just contacts the mating portion as an initial state, and in the initial state, there is a gap between the first valve core and the second valve core, or the first valve core and the second valve core contact each other and do not transmit force to each other.

6. The water purifier according to claim 4, wherein the mating portion is in clearance fit with the first valve core (32), and the sealing member (321) seals against an end surface of the mating portion (81) facing the second valve core (52).

7. The water purifier according to claim 6, wherein the first valve core includes a first valve core body and a plurality of first ribs, the plurality of first ribs are arranged at intervals and around a peripheral surface of the first valve core body, the sealing member is provided at an end of the first valve core body away from the inner cavity of the liquid reservoir and is connected to each first rib;
the mating portion is configured as an annular member and is sleeved on an outer peripheral side of each first rib and is in clearance fit with the outer peripheral side of each first rib, and an inner diameter of the mating portion is less than 7 mm;
the sealing member is configured as a disc-shaped structure, and an outer diameter of the sealing member is greater than an inner diameter of the mating portion, so as to seal the accommodating space (C).

8. The water purifier according to claim 1, wherein the first valve core includes a first sealing end and an opposite end arranged opposite to the first sealing end;
when the liquid storage unit is installed on the liquid reservoir, the mating portion is located between the opposite end and the first sealing end, the first valve assembly is open, the first sealing end is open, and the inner cavity of the liquid reservoir communicates with the accommodating space (C);
a sealing member is provided on the opposite end of the first valve core, and the sealing member is configured to sealingly cooperate with the mating portion; when the liquid storage unit is not installed on the liquid reservoir, the second connector is detached from the first connecting tube, and the sealing member sealingly cooperates with the mating portion.

9. The water purifier according to claim 4, wherein the sealing ring includes an annular main body portion and a necking portion, both the necking portion and the mating portion are disposed around an outer side of the first valve core, one end of the necking portion is connected to the main body portion, and the other end of the necking portion is connected to the mating portion.

10. The water purifier according to claim 9, wherein both the necking portion and the mating portion are located inside the main body portion; or
the main body portion, the necking portion, and the mating portion are arranged sequentially along the second direction (S); an end of the main body portion away from the necking portion is provided with a first flanging portion that is folded outward, a peripheral surface of the main body portion presses against an inner wall of the first connecting tube, and the first flanging portion is sleeved on an end of the first connecting tube away from the liquid reservoir;
the water purifier further includes a housing, the liquid reservoir is connected to the housing, the housing is provided with a connecting pipe through which the first connecting tube is inserted, an end of the connecting pipe is provided with a second flanging portion that is folded inward, and the second flanging portion presses the first flanging portion tightly against the end of the first connecting tube away from the liquid reservoir;
an inner diameter of the mating portion is less than or equal to an inner diameter of the second valve seat;
projections of surfaces of the mating portion and the second valve seat facing each other on a plane perpendicular to the first direction (F) have an overlapping portion;
an annular protruding portion is provided inside the main body portion, and when the second connector is inserted into the first connecting tube, the protruding portion presses against an outer wall of the second connector; when the second connector is inserted into the first connecting tube, at least a portion of the second connector is located between the mating portion and the main body portion.

11. The water purifier according to claim 5, wherein surfaces of the mating portion and the second valve seat facing each other are respectively designated as a first surface and a second surface;
in the initial state, an end of the first valve core away from the inner cavity of the liquid reservoir protrudes beyond the first surface;
a distance D1 between an end surface of the first valve core facing the second valve core and the first surface and a distance D2 between an end surface of the second valve core facing the first valve core and the second surface satisfy: D1<D2;
an end surface of the mating portion away from the first surface is designated as a third surface;
a first step portion that is locally protruding is provided between two ends of the first valve core, and the first step portion is configured to block a moving path of the mating portion along the first direction (F);
the first step portion includes a first step surface extending radially along the first valve core, and the first step surface is arranged opposite to the third surface;
a distance D3 between an end surface of the first valve core facing the second valve core and the first step surface and a thickness dimension D4 of the mating portion along the first direction (F) satisfy: D3>D4.

12. The water purifier according to claim 1, wherein the first valve assembly further includes a first valve seat, the first valve core passes through the first valve seat, the first valve seat is connected to the first connecting tube, the first valve core is capable of moving relative to the first valve seat along a first direction (F), or elastically resetting along a second direction(S) opposite to the first direction (F), to open or close a valve port of the first valve seat, and the first direction (F) is an insertion direction in which the second connector is inserted into the first connecting tube.

13. The water purifier according to claim 12, wherein the first valve seat includes a first valve seat body, the first valve seat body is configured with a first accommodation chamber with openings at both ends, an opening of the first accommodation chamber facing the inner cavity of the liquid reservoir forms the valve port of the first valve seat;
the first valve core passes through the first accommodation chamber and is in guiding cooperation with a wall of the first accommodation chamber, and a first sealing end of the first valve core enters the inner cavity of the liquid reservoir through the valve port of the first valve seat;
the first valve assembly further includes a first elastic member, the first elastic member is arranged between an inner wall of the first valve seat and the first valve core, so as to apply an elastic force toward the second direction(S) to the first valve core continuously;
an outer surface of the first valve core is provided with at least one second step portion, and two ends of the first elastic member press against the inner wall of the first valve seat and the at least one second step portion, respectively.

14. The water purifier according to claim 4, wherein the second valve seat includes a second valve seat body, the second valve seat body is configured with a second accommodation chamber with openings at both ends, an opening of the second accommodation chamber away from the inner cavity of the liquid storage unit forms the valve port of the second valve seat;
the second valve core passes through the second accommodation chamber and is in guiding cooperation with a wall of the second accommodation chamber, and when a second sealing end of the second valve core moves along the first direction (F), the second sealing end seals the valve port of the second valve seat.

15. The water purifier according to claim 14, wherein an edge of the valve port of the second valve seat is provided with a third flanging portion that is folded inward, and the third flanging portion is configured to stop and cooperate with the second sealing end of the second valve core;
the second valve assembly further includes a second elastic member, the second elastic member is arranged between an inner wall of the second valve seat and the second sealing end of the second valve core, so as to apply an elastic force toward the first direction (F) to the second valve core continuously; preferably, an elastic coefficient of the second elastic member is less than an elastic coefficient of the first elastic member;
an outer wall of the liquid storage unit is configured with a mounting chamber in communication with the inner cavity of the liquid storage unit, and the second connector is installed in the mounting chamber.

16. The water purifier according to claim 1, wherein the liquid reservoir is a communicating vessel, and the liquid storage unit is a clean water tank; or, the liquid reservoir is a raw water tank base, and the liquid storage unit is a raw water tank; or, the liquid reservoir is a raw water tank, and the liquid storage unit is a raw water tank base; and/or
the liquid reservoir is a communicating vessel, and the liquid storage unit is a clean water tank; the water purifier further includes: a filter and a water pump, the filter is in communication with the inner cavity of the communicating vessel, and the water pump draws water from the clean water tank through the communicating vessel; the water purifier further includes a level box, the communicating vessel is in communication with the level box, and when the water pump draws water, the water in the level box and the clean water tank both decreases;
the water purifier further includes a filter; the liquid reservoir is a raw water tank base, and the liquid storage unit is a raw water tank, and the raw water tank base is configured to provide raw water from the raw water tank to the filter; and/or the liquid reservoir communicates with atmosphere, and a water level sensor for detecting a water level is provided in the liquid reservoir.

17. A water purifier, comprising a liquid reservoir, a liquid storage unit, a first valve assembly, and a second valve assembly;
wherein the liquid reservoir is provided with a first connecting tube in communication with an inner cavity of the liquid reservoir; the liquid storage unit is provided with a second connector in communication with an inner cavity of the liquid storage unit;
the first valve assembly includes a sealing ring and a first valve core, and the first valve reciprocates along a length direction of the first connecting tube to open or close the inner cavity of the liquid reservoir), the second valve assembly includes a second valve seat and a second valve core provided on the second valve seat, the second valve core reciprocates along a length direction of the second connector to open or close the inner cavity of the liquid storage unit;
one end of the sealing ring is sealingly engaged with the first connecting tube, and the other end of the sealing ring is provided with a mating portion, and the mating portion is movably sleeved on a periphery of the first valve core;
a setting position of the second valve seat corresponds to a setting position of the mating portion, a setting position of the second valve core corresponds to a setting position of the first valve core, a state where the second connector is located in the first connecting tube and the second valve seat just contacts the mating portion is designated as an initial state, and in the initial state, there is a gap between the first valve core and the second valve core, or the first valve core and the second valve core contact each other and do not transmit force to each other.

18. The water purifier according to claim 17, wherein the first direction (F) is is parallel to a length direction of the first connecting tube;
the second valve core is movable relative to the second valve seat toward the second direction(S), or elastically resets toward the first direction (F), to open or close a valve port of the second valve seat;
the sealing ring is configured as an elastic member, and the mating portion is movable along the first direction under driving of the second valve seat, or elastically resets along the second direction, to reduce or increase a volume of the accommodating space (C);
an outer diameter of the second connector is less than an inner diameter of the main body portion;
the liquid reservoir communicates with atmosphere, and a water level sensor for detecting a water level is provided in the liquid reservoir;
a sealing member is provided on the first valve core, and the sealing member is configured to sealingly cooperate with the mating portion to seal the accommodating space (C);
the liquid reservoir is a level box, and the liquid storage unit is a clean water tank; or the liquid reservoir is a raw water tank base, and the liquid storage unit is a raw water tank; or the liquid reservoir is a raw water tank, and the liquid storage unit is a raw water tank base.

19. A water purifier, comprising:
a liquid reservoir, including a first connecting tube, a first valve assembly, and a sealing ring; wherein the first valve assembly is installed on the first connecting tube; the first valve assembly includes a first valve core, the first valve core includes a first sealing end and an opposite end arranged opposite to the first sealing end; one end of the sealing ring is in sealing cooperation with the first connecting tube, the other end of the sealing ring is provided with a mating portion, and the mating portion is movably sleeved on a periphery of the opposite end;
a liquid storage unit, detachably installed on the liquid reservoir;
wherein the first valve core, the first connecting tube, and the sealing ring together form an accommodating space (C); when the liquid storage unit is not installed on the liquid reservoir, the mating portion is located at the opposite end, the first valve assembly is closed, the first sealing end is closed, and the inner cavity of the liquid reservoir is disconnected from the accommodating space (C).

20. The water purifier according to claim 19, wherein when the liquid storage unit is installed on the liquid reservoir, the mating portion is located between the opposite end and the first sealing end, the first valve assembly is open, the first sealing end is open, and the inner cavity of the liquid reservoir communicates with the accommodating space (C);
the liquid storage unit is provided with a second connector in communication with an inner cavity of the liquid storage unit, the first valve core is configured to open or close the first valve assembly while the second connector is inserted into or pulled out of the first connecting tube;
the water purifier further includes a second valve assembly provided in the second connector;
the second valve assembly includes a driving member, and when the second connector is inserted into the first connecting tube, the driving member presses against the mating portion and drives the mating portion to detach from the opposite end, so that the second connector is in communication with the inner cavity of the liquid reservoir through the accommodating space (C);
a sealing member is provided on the opposite end of the first valve core, and the sealing member is configured to sealingly cooperate with the mating portion;
when the liquid storage unit is not installed on the liquid reservoir, the second connector is detached from the first connecting tube, and the sealing member sealingly cooperates with the mating portion.
